(19) United States
(12) Patent Application Publication
(10) Pub. No.: US 2006/0056300 A1
(43) Pub. Date: Mar. 16, 2006

(54) Bandwidth control apparatus

(76) Inventors: Yoshio Tamura, Kawasaki (JP); Yasuo Tezuka, Kawasaki (JP); Akio Yaba, Kawasaki (JP); Masanori Hashimoto, Kawasaki (JP); Kiyotaka Suzuki, Kawasaki (JP)

Correspondence Address: KATTEN MUCHIN ROSENMAN LLP, 575 MADISON AVENUE, NEW YORK, NY, 10022-2585, US

(21) Appl. No.: 11/270,348

(22) Filed: Nov. 8, 2005

Related U.S. Application Data
(63) Continuation of application No. PCT/JP03/08975, filed on Jul. 15, 2003.

(51) Int. Cl. H04J 1/16

(52) U.S. Cl. 370/235

(57) ABSTRACT

A bandwidth control apparatus in an IP network such as the Internet eliminates a packet discard for each user, and equally assigns bandwidths to the user. A bandwidth measuring portion measures a total bandwidth of a single or a plurality of TCP sessions for each user, and a window size changing portion reduces a window size of a TCP session ACK packet of a user whose total bandwidth value exceeds a maximum bandwidth preset. Alternatively, an ACK time changing portion delays a TCP session ACK packet of a user whose total bandwidth exceeds the maximum bandwidth value preset.

### BACKGROUND OF THE INVENTION

1. Field of the Invention

The present invention relates to a bandwidth control apparatus, and in particular to a bandwidth control apparatus in an IP network such as the Internet.

Recently in the Internet, high-speed access lines such as an xDSL (x Digital Subscriber Line) and an FTTH (Fiber To The Home) have become widespread, so that the bandwidth has been more and more broadened. Together with this, large-capacity contents on the basis that users use the high-speed access lines have increased. Also, high volume data transfers between users by Peer-To-Peer have also increased. In such a network, a bandwidth control technology of equally assigning a limited transmission bandwidth to users is important.

2. Description of the Related Art

FIG. 18 shows an arrangement of a general IP network. The network is composed of the Internet 300 including routers 110z_5-110z_8, an Internet service provider (ISP) 310_1 including routers 110z_1-110z_4, an ISP 310_2 to which a server 500_1 having a content 510_1 is connected, an ISP 310_3 to which a server 500_2 having a content 510_2 is connected, and an ISP 310_4 to which a user terminal 200_4 having a content 510_3 is connected.

The Internet 300 is connected to the ISP 310_1 through the routers 110z_5 and 110z_1. Furthermore, the Internet 300 is connected to the ISPs 310_2-310_4 through the routers 110z_6-110z_8 respectively.

Also, a user terminal 200_3 is connected to the router 110z_2, and user terminals 200_1 and 200_2 are connected to the router 110z_3.

The user terminal 200_1 establishes sessions 410_1-410_3 (hereinafter, occasionally represented by a reference numeral 410) respectively between the server 500_1, the server 500_2, and the user terminal 200_4 based on the TCP/IP protocol, so that data files of the contents 510_1-510_3 (hereinafter, occasionally represented by a reference numeral 510) are downloaded.

FIG. 19 shows a format of a TCP/IP packet 700 used for the establishment of the session 410 and the download of the data files in FIG. 18.

The TCP/IP packet 700 is composed of an IP header (IPv4 header in this example) 710, a TCP header 720, and data 730.

The IP header 710 includes a type of service 710a, a source address 710b, a destination address 710c, and the like. The TCP header 720 includes a source port No. 720a, a destination port No. 720b, a sequence No. 720c, an ACK No. 720d, a control 720e, a window 720f, and an option 720g. The control 720e includes an ACK bit 720e1 and a SYN bit 720e2. The option 720g includes an MSS (Max Segment Size: the maximum size of a data portion of a TCP segment (in case of MAC frame; 1460 bytes); not shown).

FIG. 20 shows an operation procedure in a case where the user terminal 200_1 in FIG. 18 downloads the content 510_1 from the server 500_1. This procedure will now be described.

Step T900 (T901-T903): A 3-way handshake is performed between the user terminal 200_1 and the server 500_1. It is to be noted that while by the 3-way handshake, control data is exchanged between the user terminal 200_1 and the server 500_1 in order to bidirectionally establish a session, where the control data for establishing the session from the server 500_1 to the user terminal 200_1 will be mainly indicated.

Step T901: The server 500_1 transmits to the user terminal 200_1 a packet 700_121 in which the SYN bit 720e2=“1” is set, to request the establishment of the session 410.

Step T902: The user terminal 200_1 returns to the server 500_1 a packet 700_122 in which the SYN bit 720e2=“1”, the ACK bit 720e1=“1”, the MSS=“1000”, and the window 720f=“4000” are set, so that a response for the establishment request of the session 410 is performed and the establishment of the session 410 in the opposite direction is requested.

Step T903: The server 500_1 returns to the user terminal 200_1 a packet 700_123 in which the ACK bit 720e1=“1” is set, to respond to the establishment request of the session 410.

Thus, the session 410 is established between the user terminal 200_1 and the server 500_1.

Step T904: The server 500_1 transmits to the user terminal 200_1 a data packet 700_125 in which the sequence No. 720c=“1000” is set.

Step T905: The user terminal 200_1 responds to the server 500_1 an ACK packet 700_124 in which the ACK bit 720e1=“1”, the ACK No. 720d=“2000” indicating the subsequent sequence No. 720c, and the window 720f=“4000” are set.

Step T906: Thereafter, the data packet 700 is transmitted from the server 500_1 to the user terminal 200_1 according to a slow start algorithm. The description thereof will be hereinafter omitted.

Steps T907-T910: The server 500_1 transmits to the user terminal 200_1 data packets 700_126-700_129 whose respective sequence Nos. 720c=“2000”, “3000”, “4000”, and “5000”.

Step T911: The user terminal 200_1 responds to the server 500_1 an ACK packet 700_130 in which the ACK bit 720e1=“1”, the ACK No. 720d=“6000”, and the window 720f=“4000” are set.

Steps T912-T915: The server 500_1 transmits to the user terminal 200_1 packets 700_131-700_134 whose respective sequence Nos. 720c=“6000”, “7000”, “8000”, and “9000”.

Step T916: The user terminal 200_1 responds to the server 500_1 an ACK packet 700_135 indicating the ACK bit 720e1=“1”, the ACK No. 720d=“10000”, and the window 720f=“4000”.

Thus, the data of the ACK Nos. 720d=“1000”-“10000” is transmitted from the server 500_1 to the user terminal 200_1.

In FIG. 21, the user terminal 200_1 establishes the session 410_1 (410_1a and 410_1b) through the routers 110z_3, 110z_1, 110z_5, and 110z_6 for downloading the content 510_1 of the server 500_1 in the network shown in FIG. 18. The user terminal 200_2 establishes the session 410_2 (410_2a and 410_2b) through the routers 110z_3, 110z_1, 110z_5, and 110z_7 for downloading the content 510_2 of the server 500_2. The user terminal 200_3 establishes the session 410_3 (410_3a and 410_3b) through the routers 110z_2, 110z_1, 110z_5, and 110z_8 for downloading the content 510_2 of the user terminal 200_4.

At this time, the user terminal 200_1 downloads the content 510_1 of the server 500_1 at a high-speed, so that the bandwidth of the router 110z_1 runs short when sessions 410_4 (410_4a and 410_4b) and 410_5 (410_5a and 410_5b) are established in parallel with the session 410_1, packet congestion occurs, and the packets of e.g. sessions 410_2 and 410_3 (indicated by dash lines) are discarded.

TCP packet retransmissions for the discarded packets are performed, which cause further packet congestion.

DiffServ Bandwidth Control

As a prior art bandwidth control method in an IP network, a DiffServ (Differentiated Service) technology can be mentioned. In the DiffServ technology, a bandwidth control is performed by using a TOS field of an IP packet.

The DiffServ is a technology of performing a priority control to relay processing within the Internet. The TOS field prepared for the header of the IP packet is newly defined as a DS (diffserv) field, in which a packet priority is described.

The DiffServ has a policing function of discarding a low-priority packet at the time of congestion, and a shaping function of excluding a burst by fixing a data rate at the time of output.

Namely, in this bandwidth control, when packets are transmitted in a bandwidth (or throughput) equal to or more than a preset value, a packet discard occurs, so that retransmission requests for the discarded packets are performed on a TCP session to which the bandwidth control is performed, leading to a problem that the packets retransmitted consume an extra bandwidth.

RED Bandwidth Control

As a bandwidth control method solving the problem of the DiffServ technology, a recent bandwidth control method by an RED (Random Early Detection) technology can be mentioned. By this bandwidth control method, packets to some extent are preliminarily discarded before the packet congestion+discard occurs, so that the congestion is avoided. However, by the bandwidth control by the RED (Random Early Detection) technology, there has been a problem that an intentional packet discard occurs.

TCP Layer Bandwidth Control Technology

Also, as a prior art bandwidth control technology in a TCP layer, systems of (1) slow start algorithm, (2) congestion avoidance algorithm, and the like can be mentioned.

(1) The slow start algorithm is for transmitting data up to 1 MSS for a single round-trip time of the TCP segment (hereinafter, occasionally referred to as packet) at an initial stage of a data transmission, and then transmitting data increased by the amount (number) of data whose ACK is returned.

(2) The congestion avoidance algorithm is for increasing a transmission data amount by 1 MSS for a single round-trip time of the TCP segment.

However, the packet discard eventually occurs at the time of the congestion of the network with only the algorithms (1) and (2), which is the same problem as that of the above-mentioned bandwidth control.

Stream Communication Bandwidth Control

Also, in an information communication terminal device (e.g. server, computer, or the like) connected to an information communication network which integrates streams, bandwidth control methods as follows can be mentioned in a stream communication of multimedia data such as a voice and an image, computer data, or the like.

Namely, a bandwidth control means is provided independently of a communication application. This means calculates a value obtained from a bandwidth a user desires and the bandwidth required by the communication application to be used as a request bandwidth of this information communication terminal device. When the requested bandwidth is equal to or less than an available bandwidth of a transmission line at that time, a transmission/reception of the stream of the communication application is started after the bandwidth of the transmission line is reserved, and when the request bandwidth exceeds the available bandwidth, a communication request from the user is rejected (e.g. see patent document 1).

However, in this bandwidth control method, the user reserves the request bandwidth for the information communication terminal device. If the bandwidth is not sufficient, the user request is rejected, the bandwidth is not equally used by the users, and the congestion discard in the network occurs.

<Patent Document 1>

Japanese Patent Application Laid-Open No. 11-98152

As described above, more and more large-capacity data is download in the Internet, and a transfer of large-capacity data is increased due to a spread of Peer-To-Peer, so that users often perform a plurality of downloads at the same time period in order to enhance an execution speed. However, a router transmission bandwidth and a router resource do not guarantee a sum total of the entire user line bandwidth. Therefore, a negative effect such as a congestion discard and a network congestion breakdown occurs.

Also, a TCP congestion control is performed for each session. Therefore, inequality occurs between users connected to a plurality of sessions and the other users. Also, it is considered that some users seize a bandwidth by intentionally setting a window size large.

Furthermore, lower-priority packets are discarded in the priority control by the prior art Diffserv, packets in excess of a bandwidth are discarded by the bandwidth control with policing, and packets are also discarded in the RED. As a result, retransmissions of the packets will occur, increasing a load of the network.

### SUMMARY OF THE INVENTION

It is an accordingly an object of the present invention to provide a bandwidth control apparatus in an IP network of the Internet or the like, by which a packet discard for each user is eliminated, and bandwidths are equally assigned to the user.

In order to achieve the above-mentioned object, a bandwidth control apparatus according to the present invention comprises: a bandwidth measuring portion measuring a total bandwidth of a single or a plurality of TCP sessions for each user; a determining portion determining whether or not the total bandwidth exceeds a maximum bandwidth value preset; and a window size changing portion reducing a window size of a TCP session ACK packet of a user whose total bandwidth exceeds the maximum bandwidth value.

FIG. 1 shows a principle of a bandwidth control apparatus of the present invention. When a user terminal 200_1 downloads files from e.g. servers 500_1 and 500_2 respectively, three TCP sessions 410_1-410_3 are established between the user terminal 200_1 and the server 500_1, and a single TCP session 410_4 is established between the user terminal 200_1 and the server 500_2. Namely, a single or a plurality of TCP sessions are established, and the files are downloaded through the TCP sessions 410_1-410_4.

As for user terminals 200_2 and 200_3, when files are similarly downloaded, a single or a plurality of TCP sessions are established (not shown).

A bandwidth measuring portion measures a total value (total bandwidth) of the bandwidths of the TCP sessions 410_1-410_4 of the user terminal 200_1. A determining portion determines whether or not the total bandwidth exceeds the maximum bandwidth value preset, so that the determination result is notified to a window size changing portion.

The window size changing portion reduces a window size (see FIG. 20) of ACK packets of the TCP sessions 410_1-410_4.

Thus, the number of total data packets (not shown) per unit time transmitted from the servers 500_1 and 500_2 to the user terminal 200_1 is reduced, thereby enabling a total bandwidth (bandwidth) to be reduced and the bandwidth to be equally assigned between users without discarding any user packet.

It is to be noted that the maximum throughput value preset may be the same value for all of the users, or may be a different value for each user.

Also, in the above-mentioned present invention, the determining portion may determine whether or not the total bandwidth exceeds a bandwidth restriction release value preset, and the window size changing portion may increase a window size of a TCP session ACK packet of a user whose total bandwidth does not exceed the bandwidth restriction release value.

Namely, the determining portion determines whether or not the total bandwidth for each user exceeds a bandwidth restriction release value preset, and a user whose total bandwidth does not exceed the bandwidth restriction release value preset is notified to the bandwidth restricting portion when the total bandwidth is not exceeded. The window size changing portion increases a window size of a TCP session ACK packet of the user notified.

Thus, it becomes possible to increase the bandwidth of the user whose total bandwidth does not exceed the bandwidth restriction release value.

Also, in order to achieve the above-mentioned object, a bandwidth control apparatus according to the present invention comprises: a bandwidth measuring portion measuring a total bandwidth of a single or a plurality of TCP sessions for each user; a determining portion determining whether or not the total bandwidth exceeds a maximum bandwidth value preset; and an ACK time changing portion delaying a TCP session ACK packet of a user whose total bandwidth exceeds the maximum bandwidth value by a predetermined time.

Namely in FIG. 1, a bandwidth measuring portion measures a total value (total bandwidth) of TCP sessions 410_1-410_4 of the user terminal 200_1, a determining portion determines whether or not the value exceeds the maximum bandwidth value preset, and the determination result is notified to an ACK time changing portion.

The ACK time changing portion transmits to the server 500_1 an ACK packet 700_1′ obtained by delaying an ACK packet 700_1 of e.g. the TCP session 410_1.

Thus, a transmission timing of a data packet (not shown) transmitted from the server 500_1 to the user terminal 200_1 is delayed, i.e. the total bandwidth of the user terminal 200_1 is reduced, thereby enabling a bandwidth to be equally assigned between users without discarding any user packet.

Also, in the above-mentioned present invention, the determining portion may determine whether or not the total bandwidth exceeds a bandwidth restriction release value preset, and the ACK time changing portion may reduce or eliminate the predetermined time of delay of the TCP session ACK packet of a user whose total bandwidth does not exceed the bandwidth restriction release value.

Namely, the determining portion determines whether or not the total bandwidth for each user exceeds a bandwidth restriction release value preset, and a user whose total bandwidth does not exceed is notified to the ACK time changing portion when the total bandwidth is not exceeded. The ACK time changing portion reduces or eliminates a transmission time delay of the TCP session ACK packet of the user notified.

Thus, it becomes possible to increase the bandwidth of the user whose total bandwidth does not exceed the bandwidth restriction release value.

Furthermore, in the present invention, the predetermined time may be determined based on a time from a reception of the ACK packet to a reception of a data packet for the ACK packet.

Namely, a round-trip time from a reception of the ACK packet on a user side to a reception of a data packet for the ACK packet from e.g. a server is measured, so that the ACK packet subsequently received is delayed by a time determined based on the round-trip time, e.g. twice the round-trip time. It is to be noted that the round-trip time may be an average round-trip time of a plurality of round-trip times.

Also, in order to achieve the above-mentioned object, a bandwidth control apparatus according to the present invention comprises: a bandwidth measuring portion measuring a total bandwidth of a single or a plurality of TCP sessions for each user and calculating a sum total bandwidth obtained by summing the total bandwidths of all of the users; a determining portion determining whether or not the sum total bandwidth exceeds a maximum bandwidth restriction value determined based on a bandwidth of a whole apparatus; and a bandwidth restricting portion performing a bandwidth restriction for each user only when the sum total bandwidth exceeds the maximum bandwidth restriction value.

Namely, a bandwidth measuring portion measures a total bandwidth for each user and calculates a sum total bandwidth obtained by summing the total bandwidths of all of the users. A bandwidth value at that time when there is no margin for the bandwidth of the entire apparatus is predetermined as a maximum bandwidth restriction value, so that a determining portion determines whether or not the sum total exceeds a maximum bandwidth restriction value, and a bandwidth restricting portion performs a bandwidth restriction for each user only when the sum total exceeds the maximum bandwidth restriction value. Thus, a packet discard can be eliminated.

Also, in the above-mentioned present invention, the bandwidth restricting portion may comprise a window size changing portion which reduces a window size of a TCP session ACK packet when the sum total bandwidth exceeds the maximum bandwidth restriction value.

Namely, a window size of a TCP session ACK packet may be reduced by using a window size changing portion as the bandwidth restricting portion when the sum total bandwidth exceeds the maximum bandwidth restriction value.

Also, in the above-mentioned present invention, the determining portion may determine whether or not the total bandwidth exceeds a preset bandwidth restriction release value equal to or less than the maximum bandwidth restriction value, and the window size changing portion may increase a window size of the TCP session ACK packet of a user whose total bandwidth does not exceed the bandwidth restriction release value.

Thus, the bandwidth of the user whose total bandwidth does not exceed the bandwidth restriction release value can be increased.

Also, in the above-mentioned present invention, the bandwidth restricting portion may comprise an ACK time changing portion which delays a TCP session ACK packet when the sum total bandwidth exceeds the maximum bandwidth restriction value.

Namely, an ACK time changing portion may be used as the bandwidth restricting portion for delaying a TCP session ACK packet when the sum total bandwidth exceeds the maximum bandwidth restriction value.

Also, in the above-mentioned present invention, the determining portion may determine whether or not the total bandwidth exceeds a preset bandwidth restriction release value equal to or less than the maximum bandwidth restriction value, and the ACK time changing portion may reduce or eliminate a delay time of the TCP session ACK packet of a user whose total bandwidth does not exceed the bandwidth restriction release value.

Thus, the bandwidth of the user whose total bandwidth does not exceed the bandwidth restriction release value can be increased.

Furthermore, in the above-mentioned present invention, the bandwidth measuring portion may be provided with a timer measuring an inter-ACK time from a first ACK for a single or a plurality of first data packets to a second ACK for a single or a plurality of second data packets after the first ACK, a counting portion counting a data length of the single or the plurality of the second data packets, and a calculating portion making the total data length divided by the inter-ACK time a bandwidth value.

Namely, the timer measures an inter-ACK time from a first ACK for a single or a plurality of first data packets to a second ACK for a single or a plurality of second data packets after the first ACK.

A counting portion counts a data length from the first ACK to the second ACK based on the ACK No. included in the first ACK and the second ACK. It is to be noted that the data length may be measured based on the data packets received from the first ACK to the second ACK.

A calculating portion makes the total data length of a single or a plurality of second data packets transmitted from the first ACK to the second ACK divided by the inter-ACK time a bandwidth value.

Thus, the bandwidth of e.g. the TCP session can be measured.

It is to be noted that a plurality of ACKs may exist between the first ACK and the second ACK. In this case, an average bandwidth value may be calculated.

### BRIEF DESCRIPTION OF THE DRAWINGS

The above and other objects and advantages of the invention will be apparent upon consideration of the following detailed description, taken in conjunction with the accompanying drawings, in which the reference numerals refer to like parts throughout and in which:

FIG. 1 is a block diagram showing a principle of a bandwidth control apparatus according to the present invention;

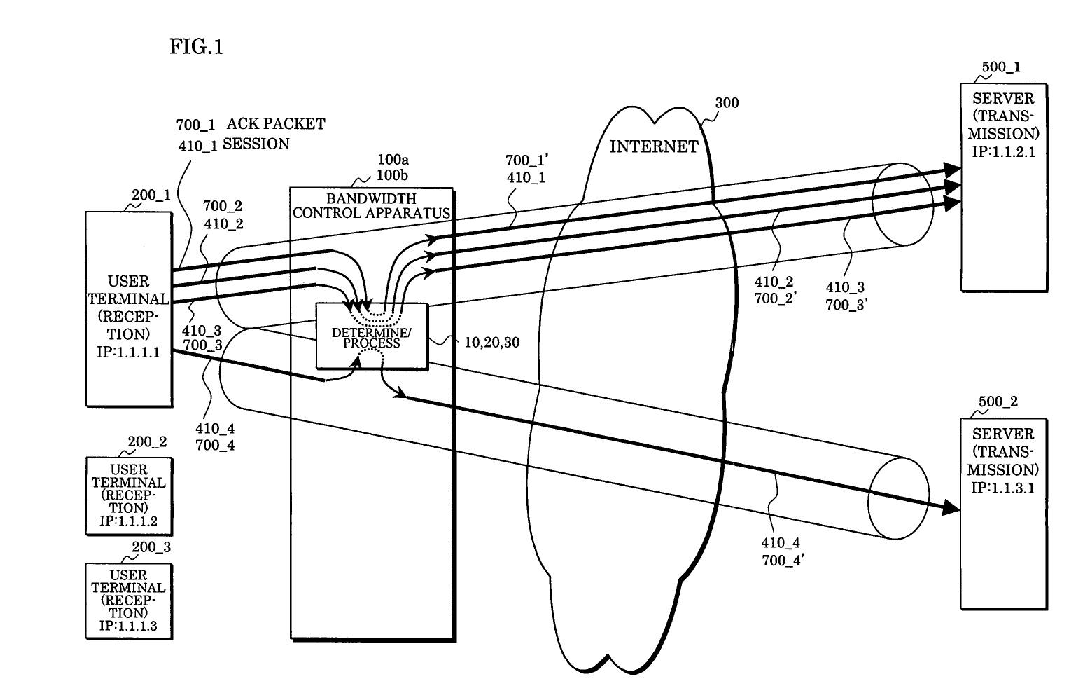

FIG. 2 is a block diagram showing an embodiment (1: window size change) of a bandwidth control apparatus according to the present invention;

FIG. 3 is a sequence diagram showing an operation procedure example (1) of a window size change in a bandwidth control apparatus according to the present invention;

FIGS. 4A-4C are diagrams showing a management table example (1) of a window size change in a bandwidth control apparatus according to the present invention;

FIG. 5 is a sequence diagram showing an operation procedure example (2) of a window size change in a bandwidth control apparatus according to the present invention;

FIG. 6 is a sequence diagram showing an operation procedure example (3) of a window size change in a bandwidth control apparatus according to the present invention;

FIGS. 7A and 7B are diagrams showing a management table example (1: continued) of a window size change in a bandwidth control apparatus according to the present invention;

FIG. 8 is a sequence diagram showing an operation procedure example (4) of a window size change in a bandwidth control apparatus according to the present invention;

FIG. 9 is a sequence diagram showing an operation procedure example (5) of a window size change in a bandwidth control apparatus according to the present invention;

FIG. 10 is a sequence diagram showing an operation procedure example (5: continued) of a bandwidth control apparatus according to the present invention;

FIG. 11 is a block diagram showing an embodiment (2: ACK time change) of a bandwidth control apparatus according to the present invention;

FIGS. 12A and 12B are diagrams showing a management table example (2) of an ACK time change in a bandwidth control apparatus according to the present invention;

FIG. 13 is a sequence diagram showing an operation procedure example (1) of an ACK time change in a bandwidth control apparatus according to the present invention;

FIG. 14 is a diagram showing an example of a total bandwidth transition in a window size change and an ACK time change of a bandwidth control apparatus according to the present invention;

FIG. 15 is a block diagram showing a network arrangement in a case where a bandwidth control of all of the bandwidth control apparatuses according to the present invention is performed;

FIGS. 16A-16D are diagrams showing a management table example in a case where a bandwidth control of all of the bandwidth control apparatuses according to the present invention is performed;

FIG. 17 is a block diagram showing a network optimized after a bandwidth control in a bandwidth control apparatus according to the present invention;

FIG. 18 is a block diagram showing a network arrangement using a general router (bandwidth control apparatus);

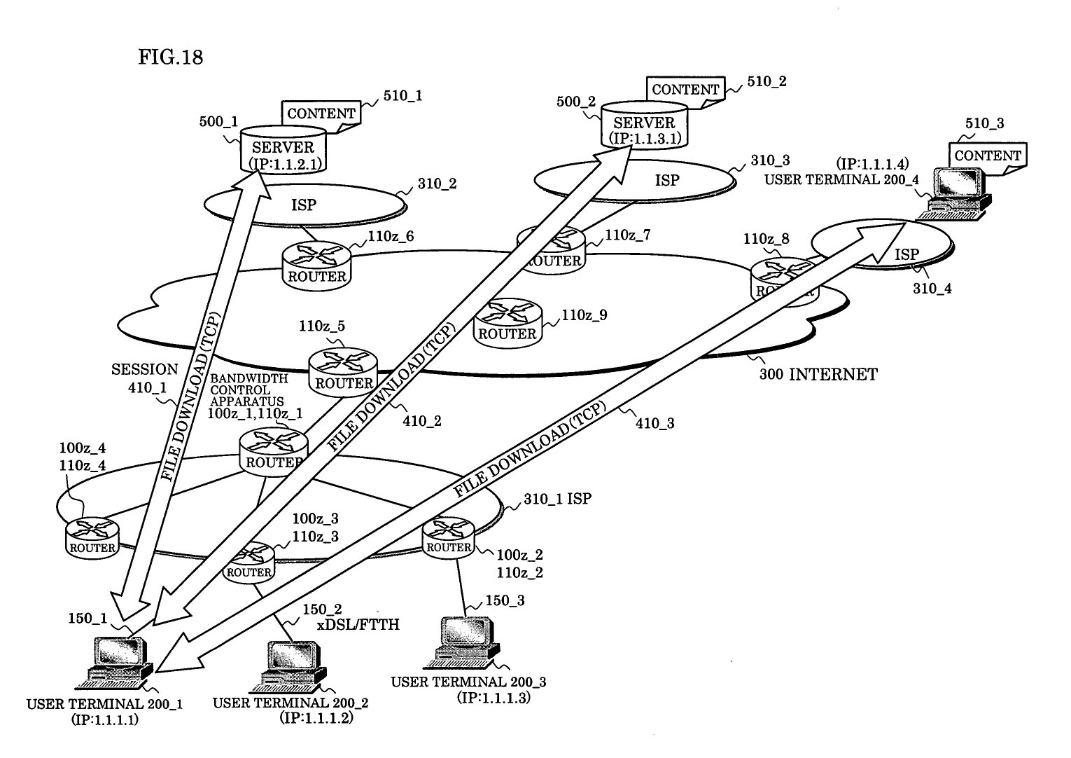

FIG. 19 is a diagram showing a format of a general TCP/IP packet;

FIG. 20 is a sequence diagram showing a data transfer operation procedure in a network using a general bandwidth control apparatus; and

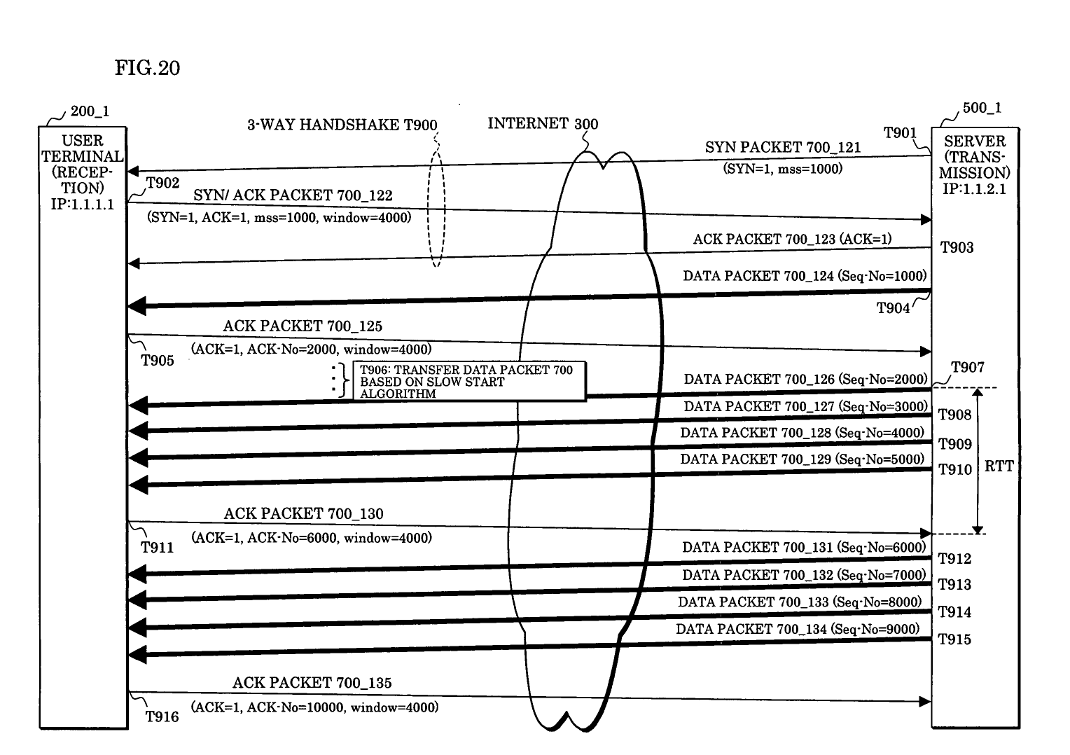

FIG. 21 is a block diagram showing a congestion occurrence state in a network using a general bandwidth control apparatus.

### DESCRIPTION OF THE EMBODIMENTS

### Embodiment (1)

### Window Size Change

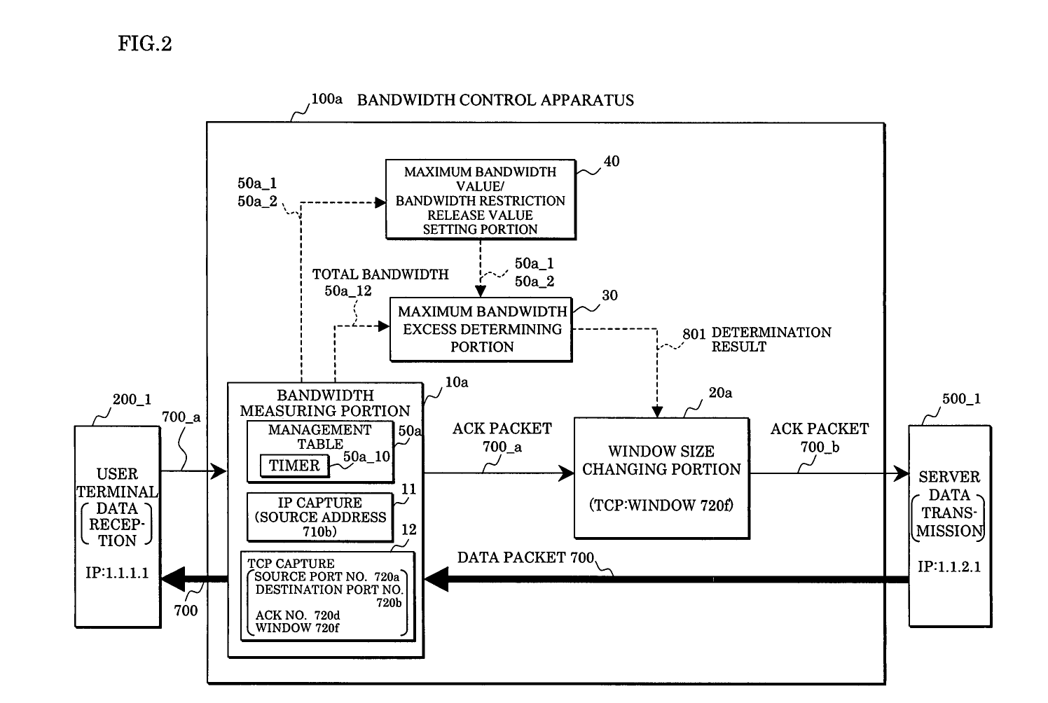

FIG. 2 shows an embodiment (1) of a bandwidth control apparatus 100a according to the present invention, which is provided with a bandwidth measuring portion 10a, a window size changing portion 20a, a maximum bandwidth excess determining portion 30, and a maximum bandwidth value/bandwidth restriction release value setting portion 40.

The bandwidth measuring portion 10a is provided with a management table 50a, an IP capture 11, and a TCP capture 12. The management table 50a includes a timer 50a_10.

In operation, the maximum bandwidth value/bandwidth restriction release value setting portion 40 provides to the maximum bandwidth excess determining portion 30 a maximum bandwidth value 50a_1 and a bandwidth restriction release value 50a_2 preset in the management table 50 or externally set by an operator. The bandwidth measuring portion 10a measures a total bandwidth 50a_12 for each user based on an ACK packet 700_{—}a received from the user terminal 200_1, provides the total bandwidth 50a_12 to the determining portion 30, and transmits the ACK packet 700_{—}a to the window size changing portion 20a.

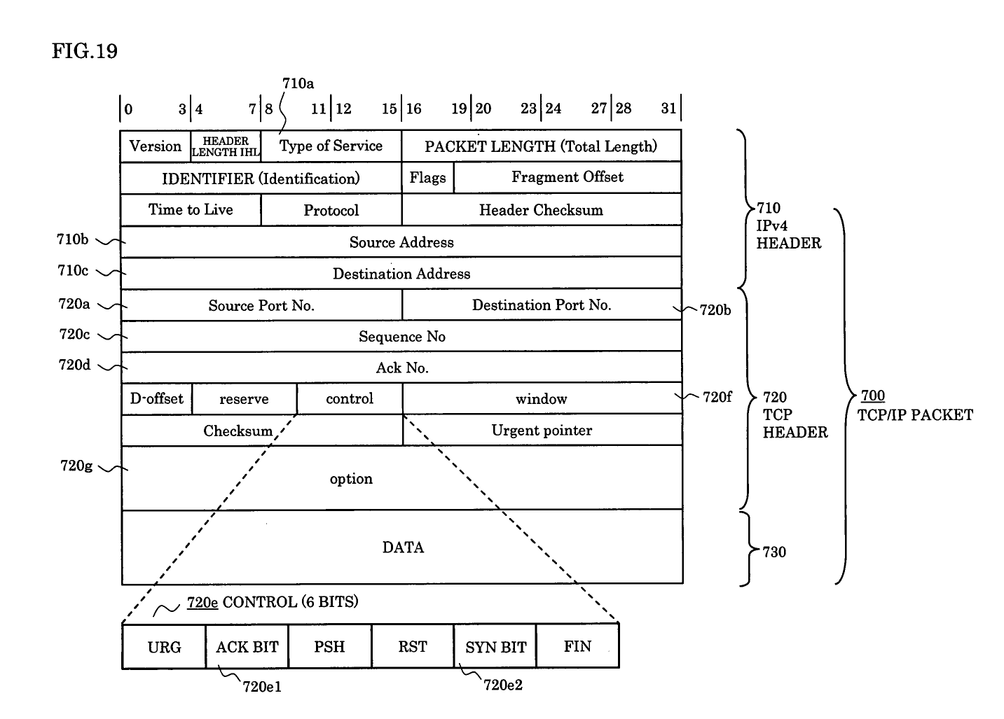

The determining portion 30 compares the maximum bandwidth value 50a_1 and the bandwidth restriction release value 50a_2 with the total bandwidth 50a_12 to provide a determination result 801 of whether or not to perform a bandwidth control, to the window size changing portion 20a. When the determination result 801 indicates that the bandwidth control is performed, the window size changing portion 20a transmits to the server 500_1 an ACK packet 700_{—}b whose window 720f (see FIG. 19) has been changed. Thus, it becomes possible to control the bandwidth (throughput) for each user.

Operation Procedure Example

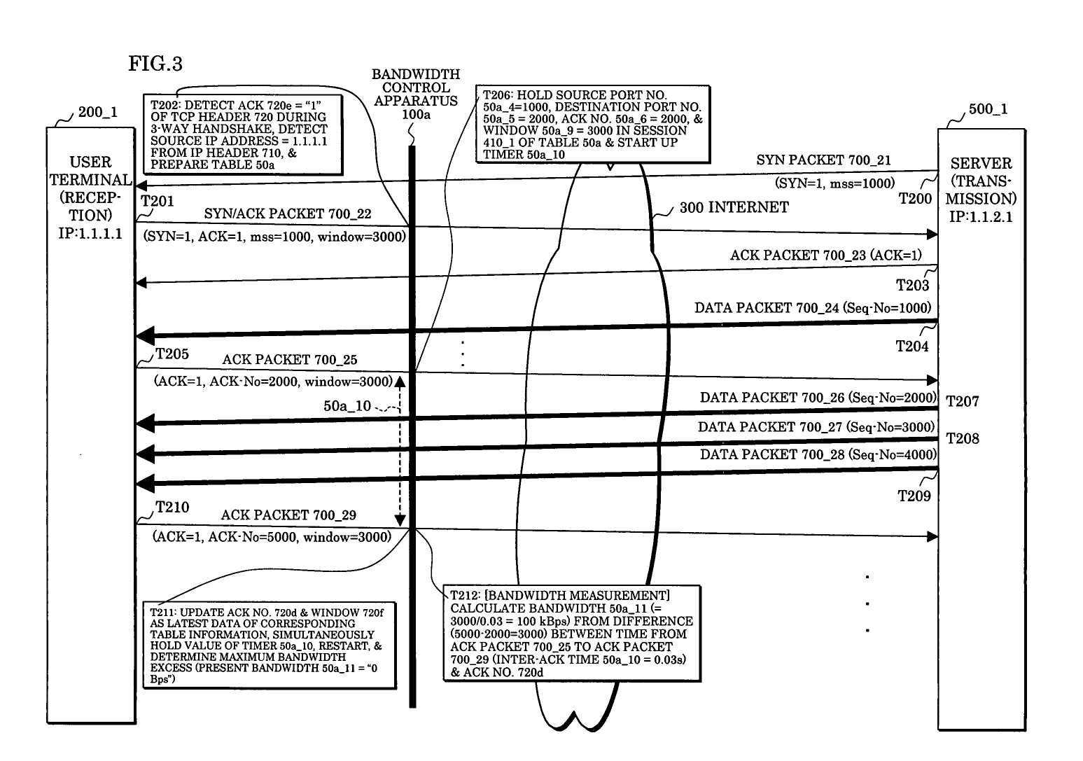

FIG. 3 shows an operation procedure example of the bandwidth control apparatus 100a of the present invention. This operation procedure example will now be described. The bandwidth control apparatus 100a is mounted on a router 110z_1, for example, in which a congestion may occur between the user terminal 200_1 (IP address=“1.1.1.1”) and the server 500_1. It is to be noted that the bandwidth control apparatus 100a may be mounted on the user terminal 200_1 or the server 500_1.

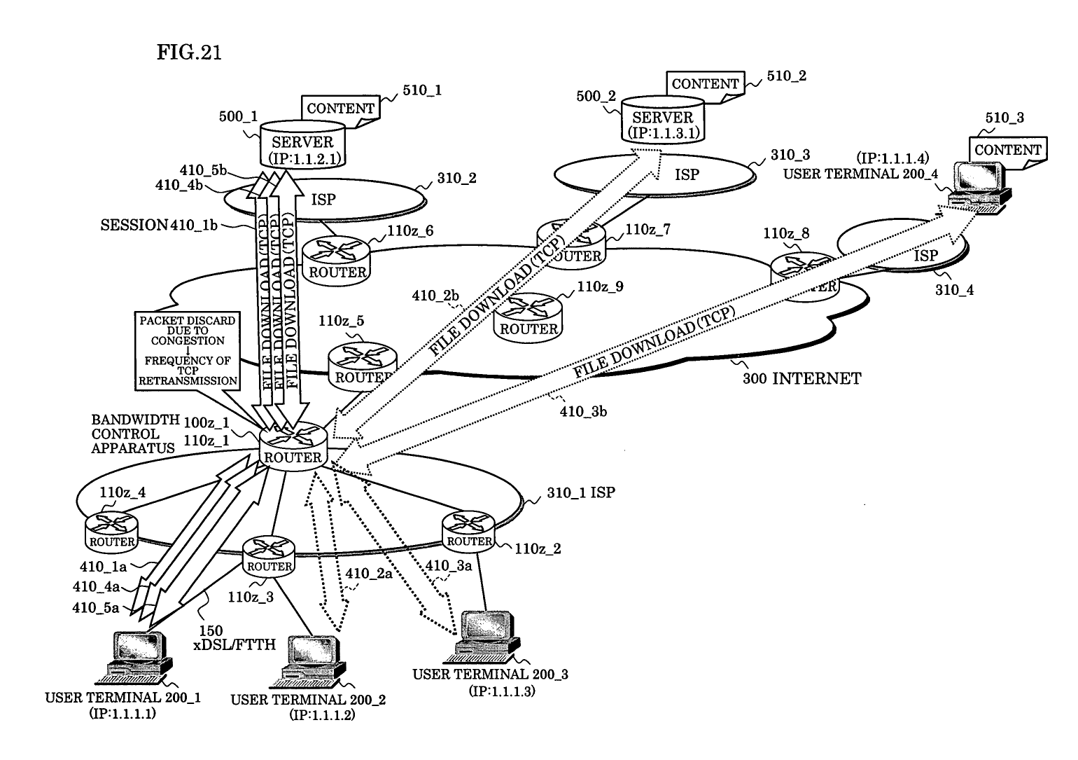

Steps T200-T203: In the same way as the prior art steps T901-T903 shown in FIG. 21, a 3-way handshake transmitting/receiving packets 700_21-700_23 at steps T200, T201, and T203 is performed, and the session 410_1 is established between the user terminal 200_1 and the server 500_1. Different from FIG. 21, step T202 is added herein.

Step T202: In the bandwidth measuring portion 10a of the bandwidth control apparatus 100a (see FIG. 2), the TCP capture 12 detects the ACK bit 720e1=“1” and the SYN bit 720e2=“1” of the TCP header 720 in the packet 700_22, and recognizes that the packet 700_22 is the SYN/ACK packet. The IP capture 11 detects the source address (IP address) 710b=“1.1.1.1” of the IP header 710 in the packet 700_22, and prepares the management table 50a corresponding to the source address 710b=“1.1.1.1”, i.e. the user terminal 200_1.

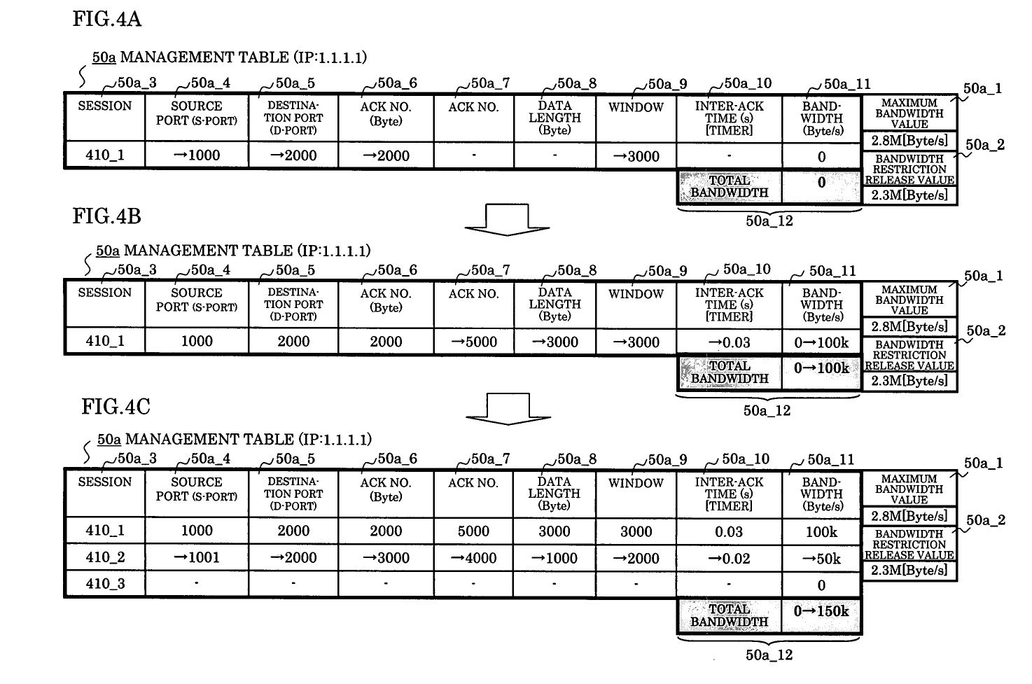

FIGS. 4A-4C show an embodiment of the management tables 50a shown in FIG. 2. The management tables 50a are tables corresponding to the user terminal 200_1 (source address=“1.1.1.1”), and are composed of the maximum bandwidth value 50a_1=“2.8 M (Byte/s)” and the bandwidth restriction release value 50a_2=“2.3 M (Byte/s)” preregistered, a session 50a_3, a source port 50a_4, a destination port 50a_5, an ACK No. 50a_6, an ACK No. 50a_7, a data length 50a_8, a window 50a_9, an inter-ACK time 50a_10 (also used as a timer), a bandwidth 50a_11, and a total bandwidth 50a_12.

The management tables 50a in FIGS. 4A and 4B show a case where only the session 410_1 is established between the user terminal 200_1 and the server 500_1.

Step T204: The server 500_1 starts a data transfer of a data packet 700_24 to the user terminal 200_1, which transmits an ACK packet (not shown) to the server 500_1. A fixed period from the data transfer start is a slow start period. While the transmission/reception of the ACK packet and the data packet is also performed in this period, the amount of data transfer during the slow start period is smaller than the amount during the large-capacity transfer. Therefore, the measurement of the bandwidth is not performed, so that the illustration and the description will be hereinafter omitted. After the slow start period, the state becomes a measurement monitoring state (measuring bandwidth for each user).

Step T205: The user terminal 200_1 transmits an ACK packet 700_25 to the server 500_1.

Step T206: In the bandwidth control apparatus 100a, the bandwidth measuring portion 10a determines that the packet is the ACK packet 700_25 since the ACK bit 720e1=“1” in the TCP header 720 of the packet 700_25.

The bandwidth measuring portion 10a sets, by referring to the IP header 710 and the TCP header 720 of the ACK packet 700_25, the session No.=“410_1”, the source port No. 720a=“1000”, the destination port No. 720b=“2000”, the ACK No. 720d=“2000”, and the window 720f=“3000” of the packet 700_25 respectively in the session 50a_3 of the management table 50a of the IP address=“1.1.1.1”, the source port 50a_4, the destination port 50a_5, the ACK No. 50a_6, and the window 50a_9 corresponding to the session 410_1 (see FIG. 4A). Furthermore, the bandwidth measuring portion 10a starts up the timer 50a_10.

Steps T207-T209: The server 500_1 transmits data packets 700_26-700_28 whose sequence Nos.=“2000”, “3000”, and “4000” respectively, to the user terminal 200_1 according to the window 720f=“3000” of the ACK packet 700_25 received.

Step T210: The user terminal 200_1 transmits an ACK packet 700_29 in which the ACK No. 720d=“5000” and the window 720f=“3000” are set addressed to the server 500_1.

Step T211: In the bandwidth control apparatus 100a, the bandwidth measuring portion 10a respectively sets the ACK No. 720d=“5000” and the window 720f=“3000” of the latest data of the ACK packet 700_29 received in the ACK No. 50a_7 and the window 50a_9 of the management table 50a (see FIG. 4B). Also, the bandwidth measuring portion 10a reads and holds the inter-ACK time 50a_10=“0.03 (s)” measured by the timer 50a_10 from the reception of the packet 700_25 to the reception of the packet 700_29, and then restarts the timer 50a_10 after the reset thereof. Furthermore, the bandwidth measuring portion 10a provides the ACK packet 700_29 received (700_{—}a in FIG. 2) to the window size changing portion 20a.

The maximum bandwidth value/bandwidth restriction release value setting portion 40 provides the maximum bandwidth value 50a_1=“2.8 M” and the bandwidth restriction release value 50a_2=“2.3 M” provided from an operator or read from the management table 50a to the maximum bandwidth excess determining portion 30.

The maximum bandwidth excess determining portion 30 determines, triggered by the reception of the ACK packet 700_29, whether or not the total bandwidth 50a_12=“0 (bandwidth (throughput) 50a_11=“100 kBps” is not calculated at this time)” read from the management table 50a exceeds the maximum bandwidth value 50a_1=“2.8 M” and provides the determination result 801=“not exceed” to the window size changing portion 20a.

The window size changing portion 20a transfers the window 720f of the ACK packet 700_29 as unchanged to the server 500_1. Thus, when the total bandwidth 50a_12 is less than the maximum bandwidth value 50a_1, the bandwidth control is not performed.
Step T212: Furthermore, the bandwidth measuring portion 10a obtains a difference between the ACK No. 50a_7=“5000” and the ACK No. 50a_6=“2000”, i.e. the data length 50a_8=“3000”, so that the bandwidth (throughput) 50a_11 is obtained from the data length 50a_8=“3000” and the inter-ACK time 50a_10=“0.03” based on the following Equation (1):

$$\text{Bandwidth} [ \text{Bytes/s} ] = \frac{Received data length [ Byte ] }{Inter \text{-} ACK time [ s ]} \qquad Eq . ( 1 )$$

The bandwidth measuring portion 10a obtains the total bandwidth 50a_12=“100 kBps” from the bandwidth 50a_11=“100 kBps” of the session 50a_3=“410_1” (see FIG. 4B).

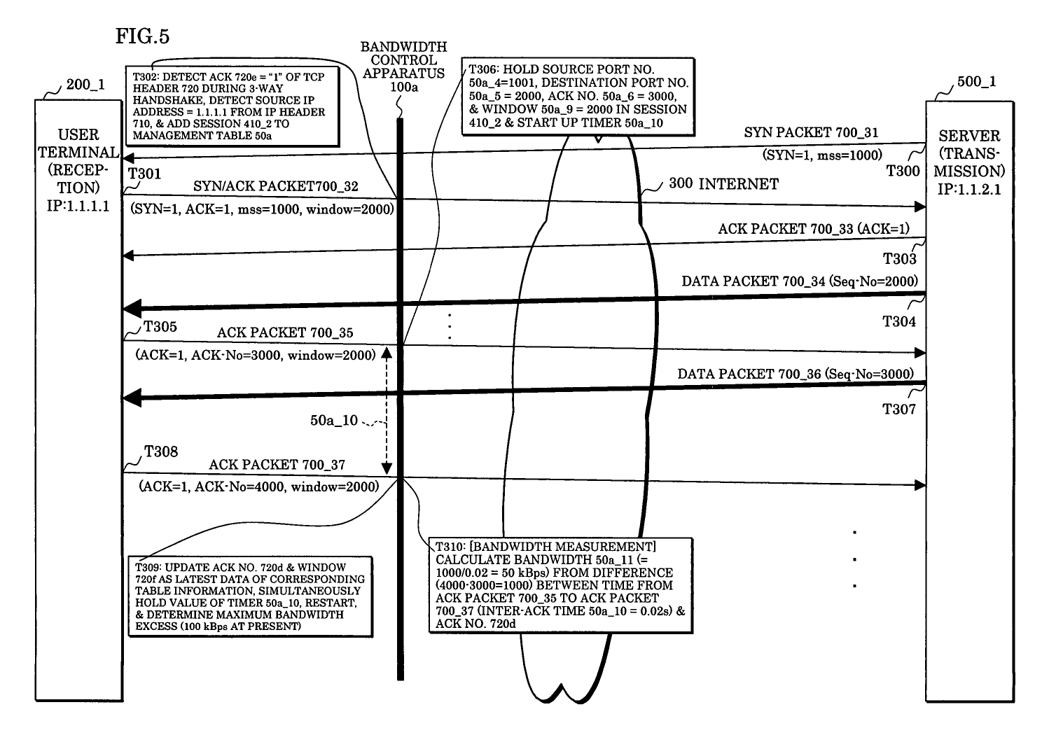

FIG. 5 shows an operation procedure example in which a session 410_2 is further established between the user terminal 200_1 and the server 500_1 to perform the data transfer. The operation procedure example will now be described.

When the user terminal 200_1 downloads data from the server 500_1 through the Internet, a single TCP session is established between the user terminal 200_1 and the server 500_1. Furthermore, when the user terminal 200_1 downloads data from the server 500_1 and another server 500_2 simultaneously, another TCP session is established. Thus, it becomes possible for a single user terminal 200_1 to establish a plurality of TCP sessions simultaneously.

Steps T300-T303: The 3-way handshake is executed, the session 410_2 is established, and a row of the session 410_2 corresponding to the source port 50a_4=“1001” is added to the management table 50a corresponding to the IP address=“1.1.1.1” (see FIG. 4C).

Step T304: The server 500_1 transmits a data packet 700_34 to the user terminal 200_1.

Steps T305 and T306: The user terminal 200_1 transmits an ACK packet 700_35 to the server 500_1. In the bandwidth control apparatus 100a, the bandwidth measuring portion 10a sets the session 50a_3=“410_2”, the source port 50a_4=“1001”, the destination port 50a_5=“2000”, the ACK No. 50a_6=“3000”, and the window 50a_9=“2000” respectively in the management table 50a (see FIG. 4C). Furthermore, the bandwidth measuring portion 10a starts up the timer 50a_10.

Step T307: The server 500_1 transmits a data packet 700_36 to the user terminal 200_1.

Step T308: The user terminal 200_1 transmits an ACK packet 700_37 in which the ACK No. 720d=“4000” and the window 720f=“2000” are set addressed to the server 500_1.

Step T309: In the bandwidth control apparatus 100a, the bandwidth measuring portion 10a sets the ACK No. 50a_7=“4000” and the window 50a_9=“2000” in the management table 50a (see FIG. 4C), and reads and holds the inter-ACK time 50a_10=“0.02 (s)” measured by the timer 50a_10 from the reception of the packet 700_35 to the reception of the packet 700_37. Then, the timer 50a_10 is restarted.

The window size changing portion 20a recognizes that the total bandwidth 50a_12=“100 k” does not exceed the maximum bandwidth value 50a_1=“2.8 M” from the destination result 801 provided from the maximum bandwidth excess determining portion 30, and transfers the ACK packet 700_37 received from the bandwidth measuring portion 10a to the server 500_1 without changing the window 720f=“2000”. The bandwidth control is not executed.

Step T310: The bandwidth measuring portion 10a calculates “4000 (=ACK No. 50a_7)”-“3000 (=ACK No. 50a_6)”=“1000 (=data length 50a_8)”, and “1000 (=data length 50a_8)”/“0.02 (=inter-ACK time 50a_10)”=“50 k (=bandwidth 50a_11)” with the Equation (1), so that the total bandwidth 50a_12=“150 k” is obtained (see FIG. 4C).

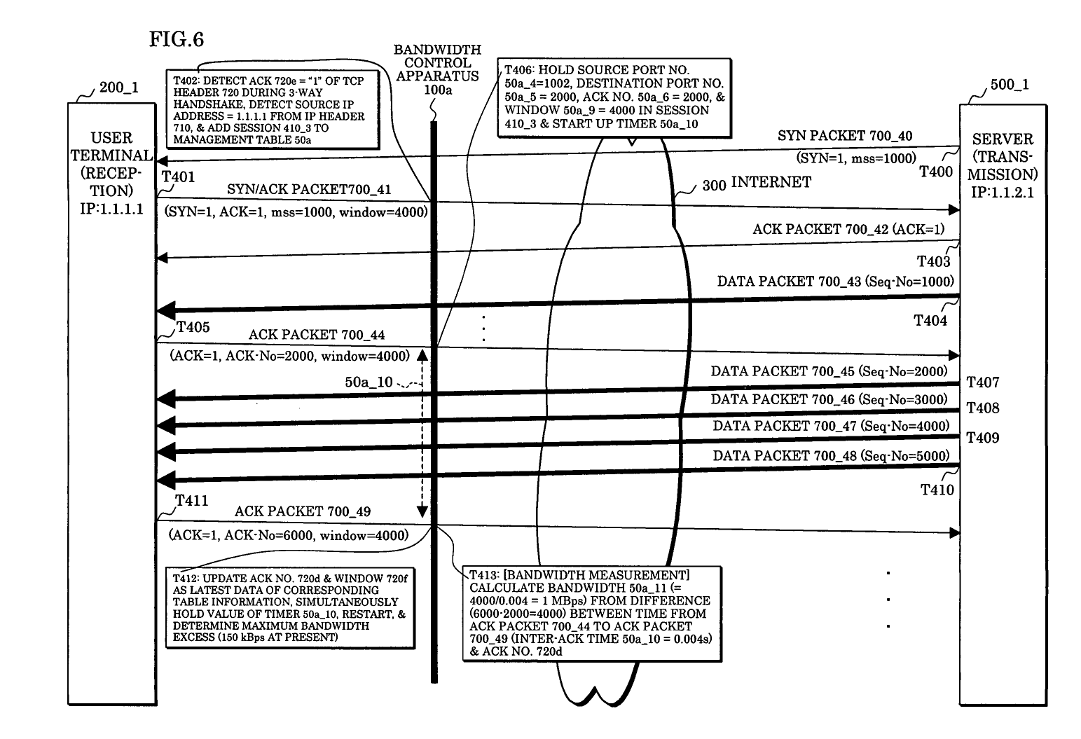

FIG. 6 shows an operation procedure example, in which a session 410_3 is further established between the user terminal 200_1 and the server 500_1 to perform the data transfer. This operation procedure example will now be described.

Steps T400-T403: The 3-way handshake is executed, the session 410_3 is established, and a row of the session 410_3 is added to the management table 50a (see FIG. 4C).

Step T404: The server 500_1 transmits a data packet 700_43 to the user terminal 200_1.

Steps T405 and T406: The user terminal 200_1 transmits an ACK packet 700_44 to the server 500_1. In the bandwidth control apparatus 100a, the bandwidth measuring portion 10a sets the session 50a_3=“410_3”, the source port 50a_4=“1002”, the destination port 50a_5=“2000”, the ACK No. 50a_6=“2000”, and the window 50a_9=“4000” respectively in the management table 50a. Furthermore, the bandwidth measuring portion 10a starts up the timer 50a_10.

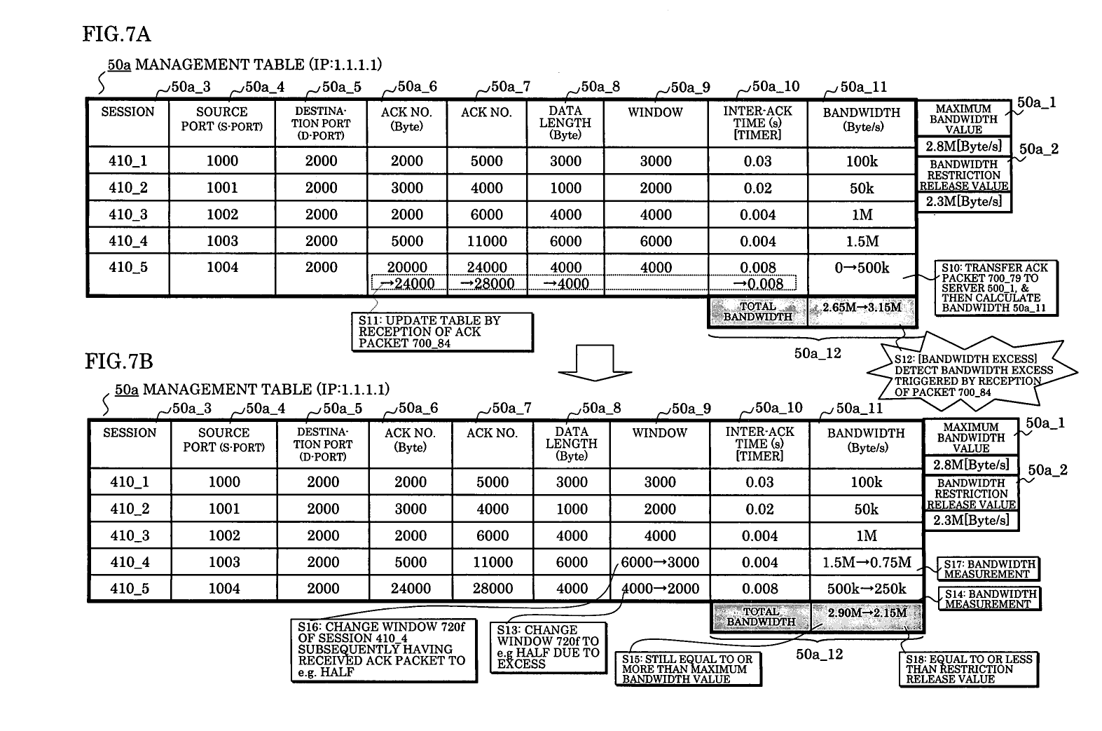

FIGS. 7A and 7B show the management tables 50a shown in FIGS. 4A-4C. In the management tables 50a, data of sessions 410_3-410_5 additionally established between the user terminal 200_1 and the server 500_1 is further registered.

Steps T407-T410: The server 500_1 transmits data packets 700_45-400_48 to the user terminal 200_1.

Step T411: The user terminal 200_1 transmits an ACK packet 700_49 in which the ACK No. 720d=“6000” and the window 720f=“4000” are set addressed to the server 500_1.

Step T412: In the bandwidth control apparatus 100a, the bandwidth measuring portion 10a sets the ACK No. 50a_7=“6000” and the window 50a_9=“4000” of the session 50a_3=“410_3” in the management table 50a (see FIG. 7A), and reads and holds time=“0.004 (s)” measured by the timer 50a_10 from the reception of the packet 700_44 to the reception of the packet 700_49. Then the timer 50a_10 is restarted.

The window size changing portion 20a recognizes that the total bandwidth 50a_12=“150 k” does not exceed the maximum bandwidth value 50a_1=“2.8 M” from the determination result 801 provided from the maximum bandwidth excess determining portion 30, and transfers the ACK packet 700_49 received from the bandwidth measuring portion 10a to the server 500_1 without changing the window 720f=“4000”. The bandwidth control is not executed.

Step T413: Furthermore, the bandwidth measuring portion 10a calculates “6000 (=ACK No. 50a_7)”-“2000 (=ACK No. 50a_6)”=“4000 (=data length 50a_8)”, and “4000”/“0.004 (=inter-ACK time 50a_10)”=“1 M (=bandwidth 50a_11)” based on the Equation (1). Thus, the total bandwidth 50a_12=“1.15 M” is obtained.

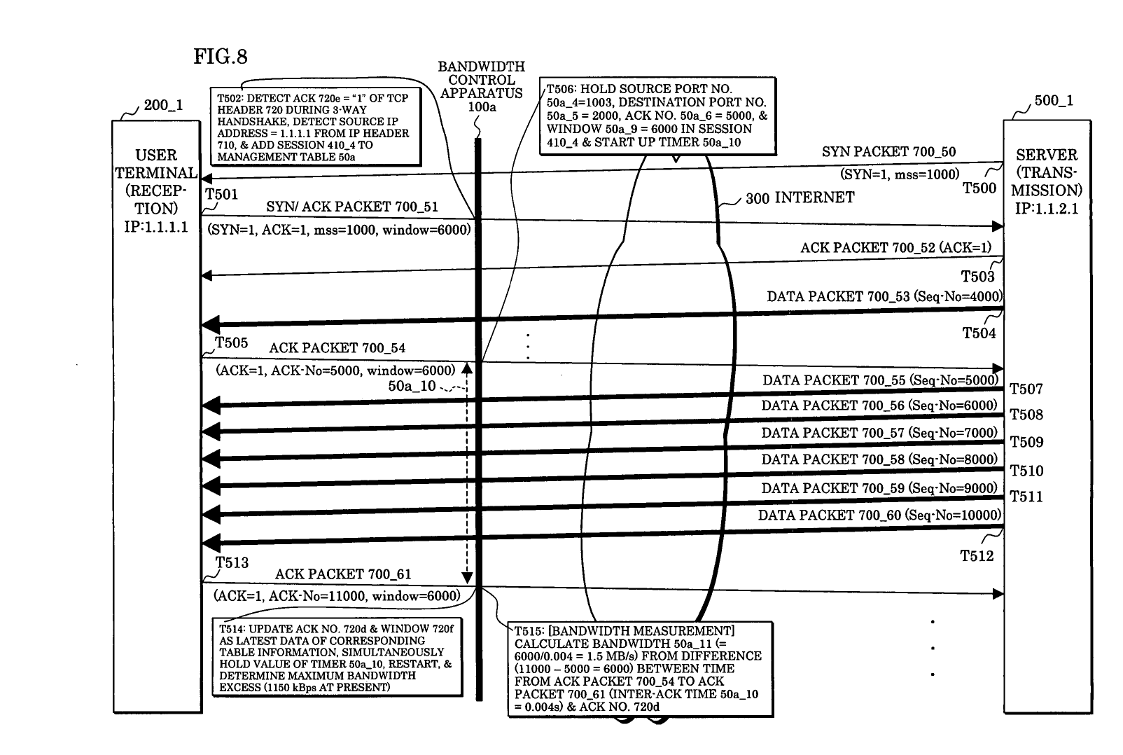

FIG. 8 shows an operation procedure example in which the session 410_4 is further established between the user terminal 200_1 and the server 500_1 to perform the data transfer. This operation procedure example will now be described.

Steps T500-T504: In the same way as steps T400-T404 of FIG. 6, the session 410_4 is established, and the row of the session 410_4 is added to the management table 50a (see FIG. 7A), so that a data packet 700_53 is transmitted from the server 500_1 to the user terminal 200_1.

Steps T505-T515: In the same way as steps T405-T413 of FIG. 6, data packets 700_55-700_60 exceeding those at steps T405-T413 by two packets are transmitted from the server 500_1 to the user terminal 200_1. The session 50a_3=“410_4”, the source port 50a_4=“1003”, the destination port 50a_5=“2000”, the ACK No. 50a_6=“5000”, the ACK No. 50a_7=“11000”, the window 50a_9=“6000”, and the data length 50a_8=“6000” are set in the management table 50a. The timer 50a_10=“0.004” is held, and is then restarted. The ACK packet 700_61 unchanged is transmitted to the server 500_1. The bandwidth 50a_11=“1.5 M” is calculated with the Equation (1), so that the total bandwidth 50a_12=“2.65 M” is obtained.

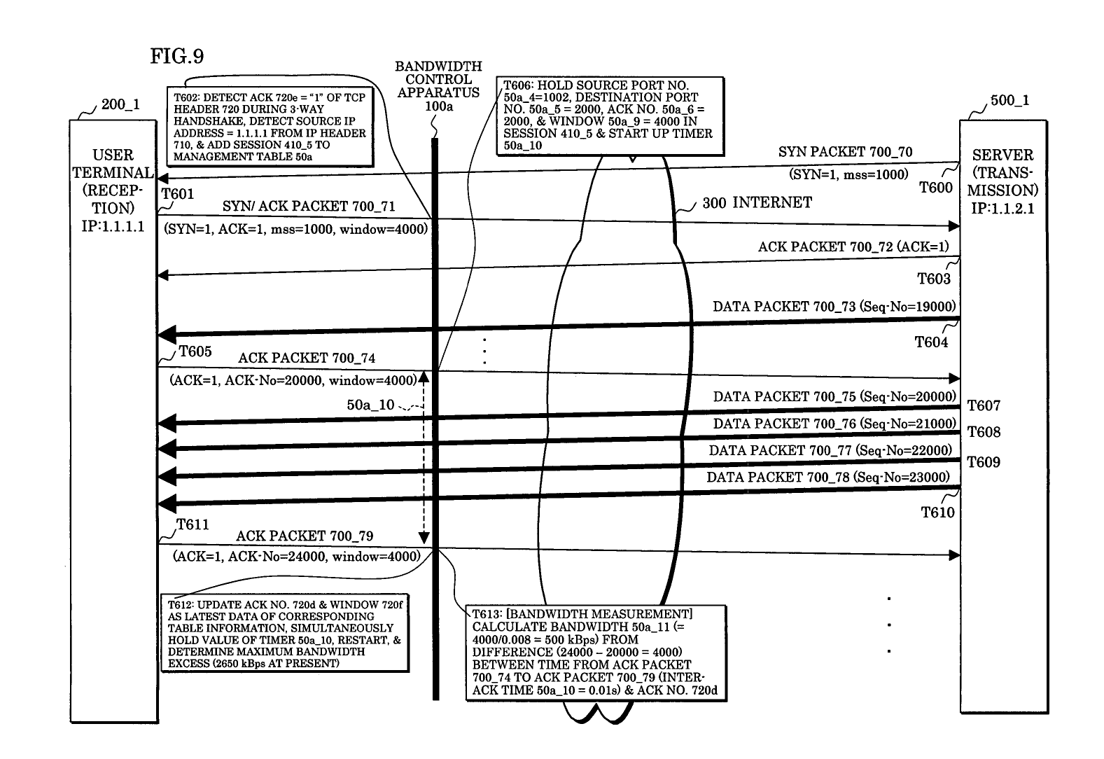

FIG. 9 shows an operation procedure example in which the session 410_5 is further established between the user terminal 200_1 and the server 500_1 to perform the data transfer. This operation procedure example will now be described.

Steps T600-T604: In the same way as steps T400-T404 of FIG. 6, the session 410_5 is established, and the row of the session 410_5 is added (see FIG. 7A) in the management table 50a, so that a data packet 700_73 is transmitted from the server 500_1 to the user terminal 200_1.

Steps T605-T613: In the same way as steps T405-T413 of FIG. 6, the source port 50a_4=“1004”, the destination port 50a_5=“2000”, the ACK No. 50a_6=“20000”, the ACK No. 50a_7=“24000”, and the window 50a_9=“4000” are set in the row of the session 50a_3=“410_5” of the management table 50a. The data length 50a_8=“4000” and the bandwidth 50a_11=“500 k” are calculated, and the timer 50a_10=“0.008 (s)” is counted, so that the timer 50a_10 is restarted after holding that time.

Also, the bandwidth measuring portion 10a provides an ACK packet 700_79 to the window size changing portion 20a, which transfers the ACK packet 700_79 unchanged to the server 500_1 based on the determination result 801 (total bandwidth 50a_12=“2.65 M”<maximum bandwidth value=“2.8 M”). At this time, the bandwidth control is not executed.

Furthermore, the bandwidth measuring portion 10a calculates the bandwidth 50a_11=“500 k” with the Equation (1) (step S10 of FIG. 7A), and then the total bandwidth 50a_12=“3.15 M” is obtained.

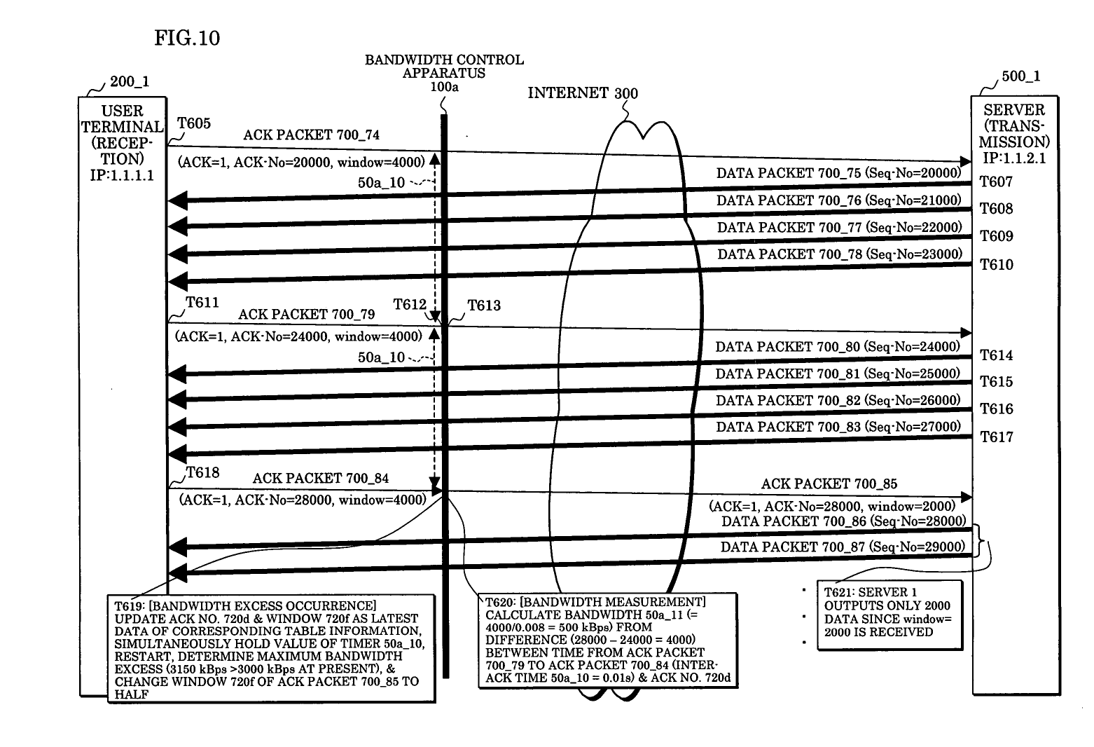

FIG. 10 shows the data transfer continued in the session 410_5 shown in FIG. 9.

Steps T605-T613: These steps indicate the same steps of steps T605-T613 in FIG. 9.

Steps T614-T619: The source port 50a_4=“1004”, the destination port 50a_5=“2000”, the ACK No. 50a_6=“24000”, the ACK No. 50a_7=“28000”, and the window 50a_9=“4000” are reset (see step S11 of FIG. 7A) in the row of the session 50a_3=“410_5” of the management table 50a (see FIG. 7A). After the timer 50a_10=“0.008 (s)” counted is held, the timer 50a_10 is restarted.

The window size changing portion 20a performs the bandwidth control (see step S13 of FIG. 7B) of transmitting to the server 500_1 an ACK packet 700_85 in which the window 720f=“4000” of an ACK packet 700_84 is reduced to half “2000”, for example, based on the determination result 801 (total bandwidth 50a_12=“3.15 M”>the maximum bandwidth value 50a_1=“2.8 M”: detection of bandwidth excess; see step S12 of FIG. 7A).

Step T620: After calculating the data length 50a_8=“4000” and the bandwidth 50a_11=“500 k”, the total bandwidth 50a_12=“3.15 M” is obtained.

Subsequent operation will now be described referring to FIG. 7B.

Steps S14 and S15: Since the server 500_1 transmits data within the designated window size, data packets as well as the bandwidth are reduced. Namely, the bandwidth 50a_11 of the session 410_5 is reduced to “250 k”, so that the total bandwidth 50a_12 is made “2.9 M”.

Step S16: Since the total bandwidth 50a_12=“2.9 M” still exceeds the maximum bandwidth value 50a_1=“2.8 M”, the bandwidth control of setting the window 720f=“3000”, half of “6000” is performed for the session 410_4 subsequently having received the ACK packet.

Steps S17 and S18: The bandwidth 50a_11 of session 410_4 is reduced to “0.75 M”, and the bandwidth restriction release value assumes “2.3 M”<total bandwidth 50a_12=“2.15 M”<maximum bandwidth value 50a_1=“2.8 M”. Hereafter, the value of the window 720f of the ACK packet 700 in the session 410 subsequently having received is not changed to be transmitted transparently. Thus, an equal bandwidth control can be performed to all of the users.

It is to be noted that the above-mentioned bandwidth control indicates a case where the maximum bandwidth of each user is restricted to 2.8 MByte/s, and the maximum bandwidth is determined based on the total bandwidth regardless of the number of sessions and the window size.

### Embodiment (2)

### ACK Time Change

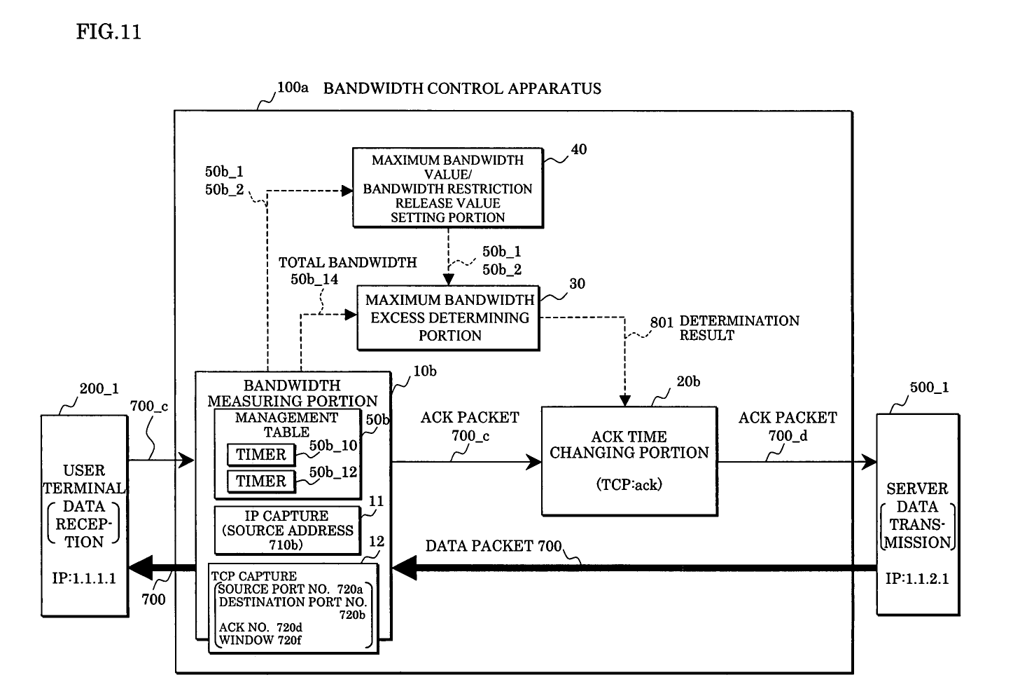

FIG. 11 shows an embodiment (2) of a bandwidth control apparatus 10b according to the present invention. This bandwidth control apparatus 10b is different from the bandwidth control apparatus 100a shown in FIG. 2 in that an ACK time changing portion 20b and a bandwidth measuring portion 10b are respectively substituted for the window size changing portion 20a and the bandwidth measuring portion 10a, and a management table 50b composing the bandwidth measuring portion 10b is provided with two timers 50b_10 and 50b_12.

Also, different from the bandwidth control apparatus 100a, the bandwidth measuring portion 10b provides a maximum bandwidth value 50b_1 and a bandwidth restriction release value 50b_2 to the maximum bandwidth value/bandwidth restriction release value setting portion 40, and a total bandwidth 50b_14 is provided to the maximum bandwidth excess determining portion 30.

In operation, the bandwidth control apparatus 100b is different from the bandwidth control apparatus 100a in that the ACK time changing portion 20b delays a time for transferring the ACK packet 700_{—}b received by each user based on the determination result of whether or not the total bandwidth exceeds the maximum bandwidth value 50b_1 or the bandwidth restriction release value 50b_2 preset.

This delay time is increased to e.g. 180% of a reference time by taking a response time from the reception of the ACK packet (e.g. ACK No. 720d=“2000”) at the server 500_1 up to the reception of the corresponding data packet (e.g. sequence No. 720c=“2000”) as a reference.

It is to be noted that in order to enhance the reliability of the response time, an average response time is used. Also, the average response time is determined in consideration of the discard, delay, or the like of the received data packet.

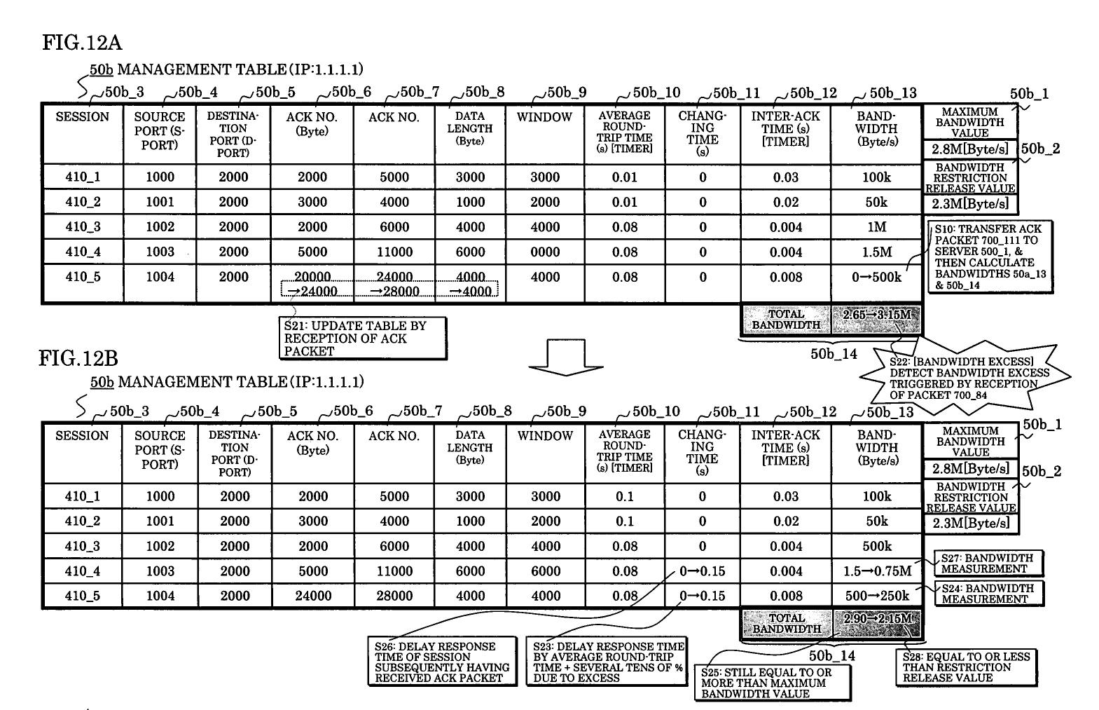

FIGS. 12A and 12B show an embodiment of the management tables 50b shown in FIG. 11. The management table 50b is different from the management table 50a shown in FIGS. 7A and 7B in that an average round-trip time 50b_10 and a change time 50b_11 are added.

The management table 50b is prepared for each user (IP address) in the same way as the operation procedure examples of the bandwidth control apparatus 100a shown in FIGS. 3, 5, 6, and 8-10, and the bandwidth of the session corresponding to the same user is measured based on the Equation (1), so that the total bandwidth of all of the sessions of the users can be obtained.

FIG. 12A shows values set when the ACK packets 700 and the data packets 700 in the same way as the operation procedure of the bandwidth control apparatus 100a shown in FIGS. 3, 5, 6, and 8-10 are transmitted/received between the user terminal 200_1 and the server 500_1. The values of the data set in a source port 50b_4, a destination port 50b_5, an ACK No. 50b_6, an ACK No. 50b_7, a data length 50b_8, a window 50b_9, an inter-ACK time 50b_12, a bandwidth 50b_13, and a total bandwidth 50b_14 of the sessions 410_1-410_5 are respectively the same as the values of the source port 50a_4, the destination port 50a_5, the ACK No. 50a_6, the ACK No. 50a_7, the data length 50a_8, the window 50a_9, the inter-ACK time 50a_10, the bandwidth 50a_11, and the total bandwidth 50a_12 of sessions 410_1-410_5 in FIG. 7A.

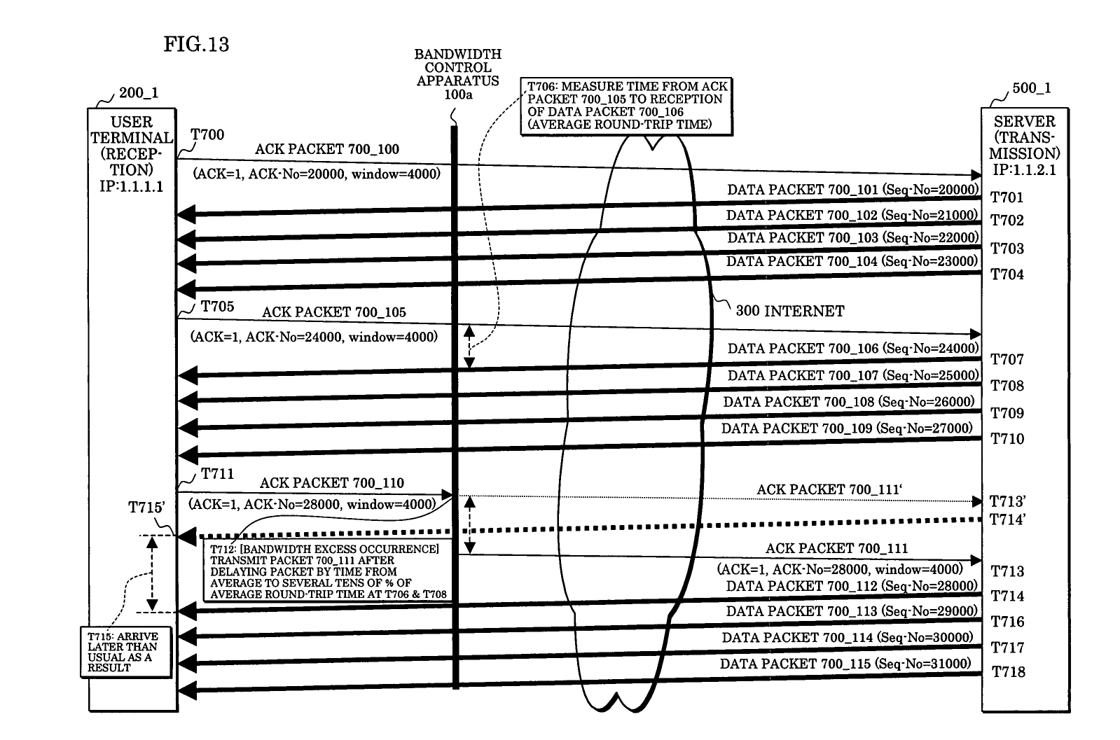

FIG. 13 shows an operation procedure of the bandwidth control apparatus 10b, which will now be described. In the same way as steps T605-T618 shown in FIG. 10, the session 410_5 of the user terminal 200_1 is added, and then the ACK packet and the data packet are transmitted/received between the user terminal 200_1 and the server 500_1.

Step T700: The user terminal 200_1 transmits an ACK packet 700_100 to the server 500_1.

Steps T701-T704: The server 500_1 transmits data packets 700_101-700_104 to the user terminal 200_1.

Step T705: The user terminal 200_1 transmits an ACK packet 700_105 to the server 500_1.

Step T706: In the bandwidth measuring portion 10b having received the ACK packet 700_105 whose ACK No. 720d=“2000”, the timers 50b_10 and 50b_12 within the management table 50b are started up. Hereafter, the operation of the timer 50b_12 is the same as that of the timer 50a_10 shown in FIGS. 7A and 7B, so that the description will be hereinafter omitted.

Steps T707-T710: The server 500_1 transmits data packets 700_106-700_109 to the user terminal 200_1. When the data packet 700_106 whose sequence No. 720c=“24000” which is the same as the ACK No. 720d=“24000” is received in the bandwidth measuring portion 10b, the timer 50b_10 stops. Namely, the timer 50b_10 measures the average round-trip time 50b_10 (time from the transfer of the ACK packet 700_105 to the reception of the data packet 700_106). It is to be noted that as for the average round-trip time 50b_10, the measurement is performed every time the ACK packet is received for each session 410_1-410_5, so that “0.01 (s)”, “0.01 (s)”, “0.08 (s)”, “0.08 (s)”, and “0.08 (s)” are respectively measured in FIG. 12A.

Step T711: The user terminal 200_1 transmits an ACK packet 700_110 to the server 500_1.

Step T712: In the bandwidth control apparatus 10b, like steps T619 and T620 of FIG. 10, the maximum bandwidth excess determining portion 30 detects the bandwidth excess occurrence, and the ACK time changing portion 20b transfers to the server 500_1 an ACK packet 700_111 which is obtained by delaying the ACK packet 700_110 by “0.15 (s)” which is 188% of “0.08 (s)” held in the timer 50b_10.

Steps T713-T718: The server 500_1 transmits data packets 700_112-700_115 to the user terminal 200_1.

Step T719: As a result, when e.g. the ACK packet 700_110 is not delayed, the data packet 700_112 is supposed to arrive at the user terminal 200_1 at the time T715′. However, the packet arrives after being delayed by the time T715, thereby reducing the bandwidth of the session 410_5. Accordingly, the total bandwidth 50b_14 of the user terminal 200_1 can be also reduced.

Hereafter, steps S20-S28 similar to the steps S10-S18 shown in FIGS. 7A and 7B are executed, so that when the total bandwidth 50b_14 exceeds the maximum bandwidth value 50b_1, the ACK packet is delayed.

If the bandwidth excess is eliminated in the subsequent maximum bandwidth excess determination, all of the sessions 410_1-410_5 operate with an unchanged delay time. Furthermore, if the total bandwidth 50b_14 of the user becomes less than the bandwidth restriction release value 50b_2 hereafter, the changing time of the session 410_1 by which the ACK packet is delayed is made “0 (s)”, so that the ACK packet from the user terminal 200_1 is transferred transparently without being changed and delayed.

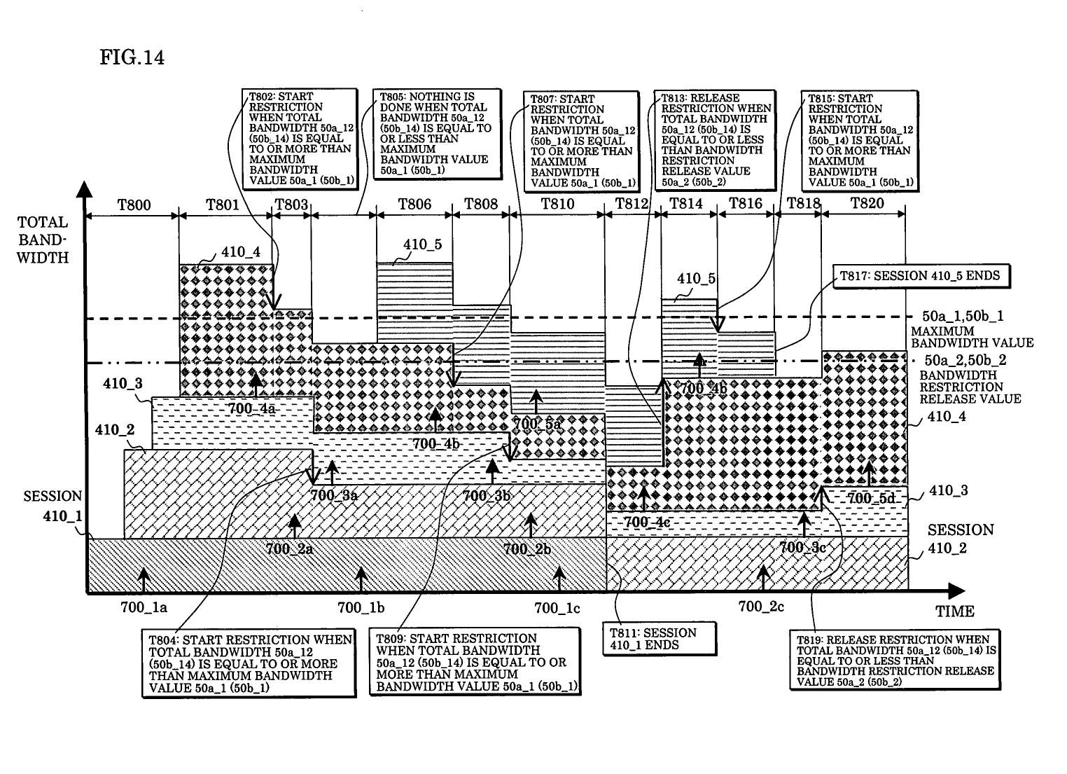

FIG. 14 shows a temporal transition of the bandwidth 50a_11 or 50b_13 and the total bandwidth 50a_12 or 50b_14 of the sessions 410_1-410_5 in the bandwidth control of the above-mentioned embodiment (1) or (2). This transition will now be described.

Step T800: The sessions 410_1-410_3 are sequentially established.

Steps T801 and T802: The session 410_4 is established. With an ACK packet 700_4a of the session 410_4 as a trigger, it is recognized that the total bandwidth 50a_12 is equal to or more than the maximum bandwidth value 50a_1, so that the bandwidth restriction of the session 410_4 is started.

Steps T803 and T804: With an ACK packet 700_2a of the session 410_2 as a trigger, it is recognized that the total bandwidth 50a_12 is still equal to or more than the maximum bandwidth value 50a_1, so that the bandwidth restriction of the session 410_2 is started.

Step T805: The total bandwidth 50a_12 is equal to or less than the maximum bandwidth value 50a_1, so that the bandwidth restriction is kept unchanged.

Steps T806 and T807: The session 410_5 is established. With an ACK packet 700_4b of the session 410_4 as a trigger, it is recognized that the total bandwidth 50a_12 is equal to or more than the maximum bandwidth value 50a_1, so that the bandwidth restriction of the session 410_4 is started.

Steps T808 and T809: With an ACK packet 700_3b of the session 410_3 as a trigger, it is recognized that the total bandwidth 50a_12 is still equal to or more than the maximum bandwidth value 50a_1, so that the bandwidth restriction of the session 410_3 is started.

Step T810: The bandwidth 50a_12 is equal to or less than the maximum bandwidth value 50a_1, so that the bandwidth restriction is kept unchanged.

Steps T811 and T812: The session 410_1 ends, so that the total bandwidth 50a_12 is equal to or less than the bandwidth restriction release value 50a_2.

Step T813: With an ACK packet 700_4c of the session 410_4 as a trigger, it is recognized that the total bandwidth 50a_12 is equal to or less than the bandwidth restriction released value 50a_2, so that the bandwidth restriction of the session 410_4 is released.

Steps T814 and T815: The total bandwidth 50a_12 is equal to or more than the maximum bandwidth value 50a_1. With an ACK packet 700_5b of the session 410_5 as a trigger, it is recognized that the total bandwidth 50a_12 is equal to or more than the maximum bandwidth value 50a_1, so that the bandwidth restriction of the session 410_5 is started.

Step T816: The total bandwidth 50a_12 is equal to or less than the maximum bandwidth value 50a_1, so that the bandwidth restriction is kept unchanged.

Steps T817 and T818: The session 410_5 ends, so that the total bandwidth 50a_12 is equal to or less than the bandwidth restriction release value 50a_2.

Step T819: With an ACK packet 700_3c of the session 410_3 as a trigger, it is recognized that the total bandwidth 50a_12 is equal to or less than the bandwidth restriction release value 50a_2, so that the bandwidth restriction of the session 410_3 is released.

Step T820: The total bandwidth 50a_12 is equal to or more than the bandwidth restriction release value 50a_2 and equal to or less than the maximum bandwidth value 50a_1, so that the state of performing no bandwidth restriction is kept unchanged.

Thus, the bandwidth control of the total bandwidth 50a_12 corresponding to the user is supposed to be performed.

### Embodiment (3)

### Network in which the Bandwidth of all of the Apparatuses is Adjusted

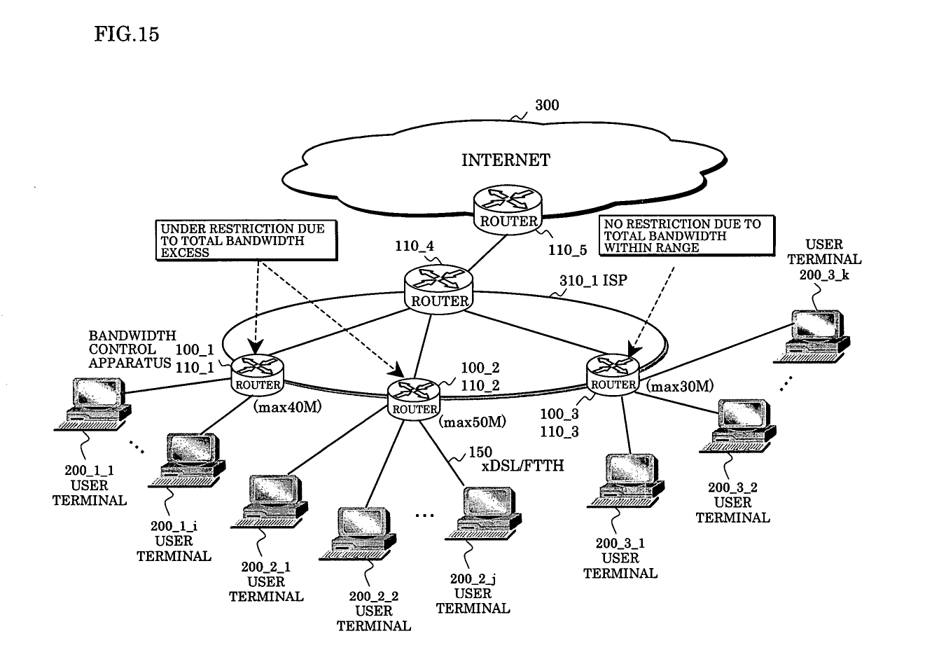

FIG. 15 shows an ISP 310_1, which accommodates a plurality of users and is connected to the Internet 300. Namely, the ISP 310_1 accommodates user terminals 200_1_1-200_1_{—}i, user terminals 200_2_1-200_2j, user terminals 200_3_1-200_3_{—}k (hereinafter, occasionally represented by a reference numeral 200) in routers 110_1-110_3 (hereinafter, occasionally represented by a reference numeral 110) mounted on a user side, and the ISP 310_1 is connected to the Internet 300 through routers 110_4 and 110_5.

The routers 110_1-110_3 are respectively provided with bandwidth control apparatuses 100_1-100_3 of the present invention, which respectively include management tables 60_1-60_3 (not shown).

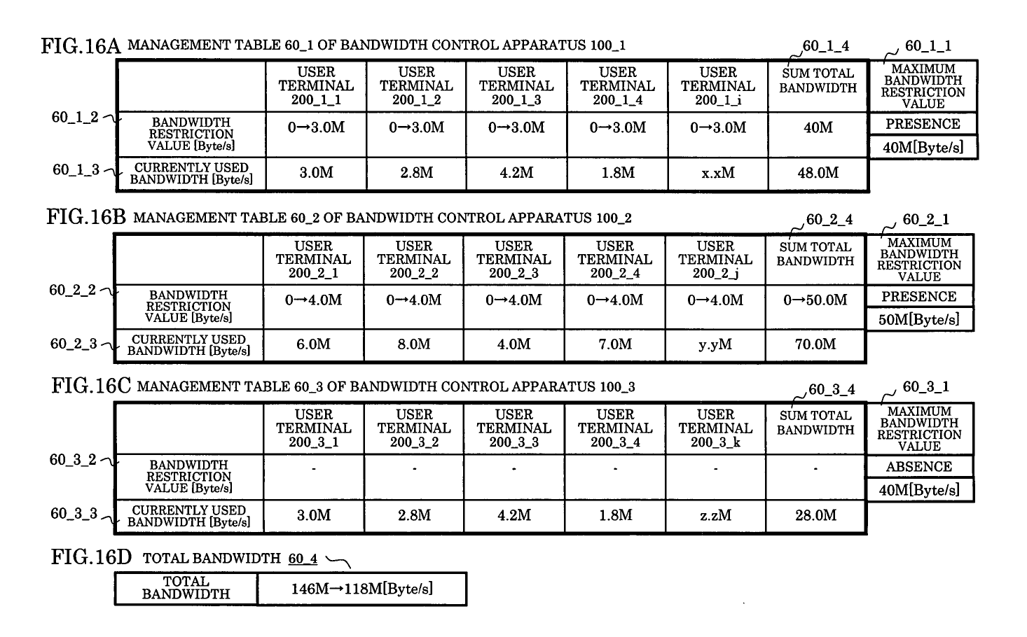

FIGS. 16A-16C respectively show the management tables 60_1-60_3, which are respectively composed of maximum bandwidth restriction values 60_1_1-60_3_1, a bandwidth restriction value 60_1_2 and a currently used bandwidth 60_1_3, a bandwidth restriction value 60_2_2 and a currently used bandwidth 60_2_3, a bandwidth restriction value 60_3_2 and a currently used bandwidth 60_3_3, and sum total bandwidths 60_1_4-60_3_4 of the user terminals 200 connected to the corresponding routers 110.

The maximum bandwidth restriction values 60_1_1-60_3_1 include a field indicating presence/absence of the bandwidth restriction for each user.

FIG. 16D shows a sum total bandwidth 60_4, in which the sum total bandwidths 60_1_4-60_3_4 of the currently used bandwidths 60_1_3-60_3_3 of the management tables 60_1-60_3 are aggregated.

The currently used bandwidths of user terminals 200_1_1-200_1_{—}i in the management table 60_1 are respectively 3.0 MBps-x.x MBps, and the sum total bandwidth 60_1_4 is 48.0 MBps. Similarly, the sum total bandwidths 60_2_4 and 60_3_4 of the management tables 60_2 and 60_3 are respectively 70.0 MBps and 28.0 MBps. The total of the sum total bandwidths 60_1_4-60_3_4 is the sum total bandwidth 60_4=“146 M”.

In operation, a controller (not shown) of the ISP 310_1 calculates the sum total bandwidth 60_4=“146 MBps” of the bandwidth control apparatuses 100_1-100_3. When the sum total bandwidth exceeds the preset maximum bandwidth value=“130 MBps”, the bandwidth restriction is performed by router or by user.

In the management tables 60_1-60_3, the maximum bandwidth restriction value 60_1_1=“presence, 40 M”, the maximum bandwidth restriction value 60_2_1=“presence, 50 M”, the maximum bandwidth restriction value 60_3_1=“absence, 40 M” are set for each router (bandwidth control apparatus).

In the management tables 60_1 and 60_2, “3.0 M” and “4.0 M” are respectively set for each user terminal. Since the sum total bandwidth 60_3_4=“28.0 M” of the currently used bandwidth does not reach the maximum bandwidth restriction value 60_3_1=“40 M” in the management table 60_3, the bandwidth restriction is not performed to the user terminal.

Thus, it becomes possible to perform a data transfer in the ISP 310_1 with the user terminal 200 in the Internet 300 or the ISP 310_1 without an occurrence of discard due to a congestion.

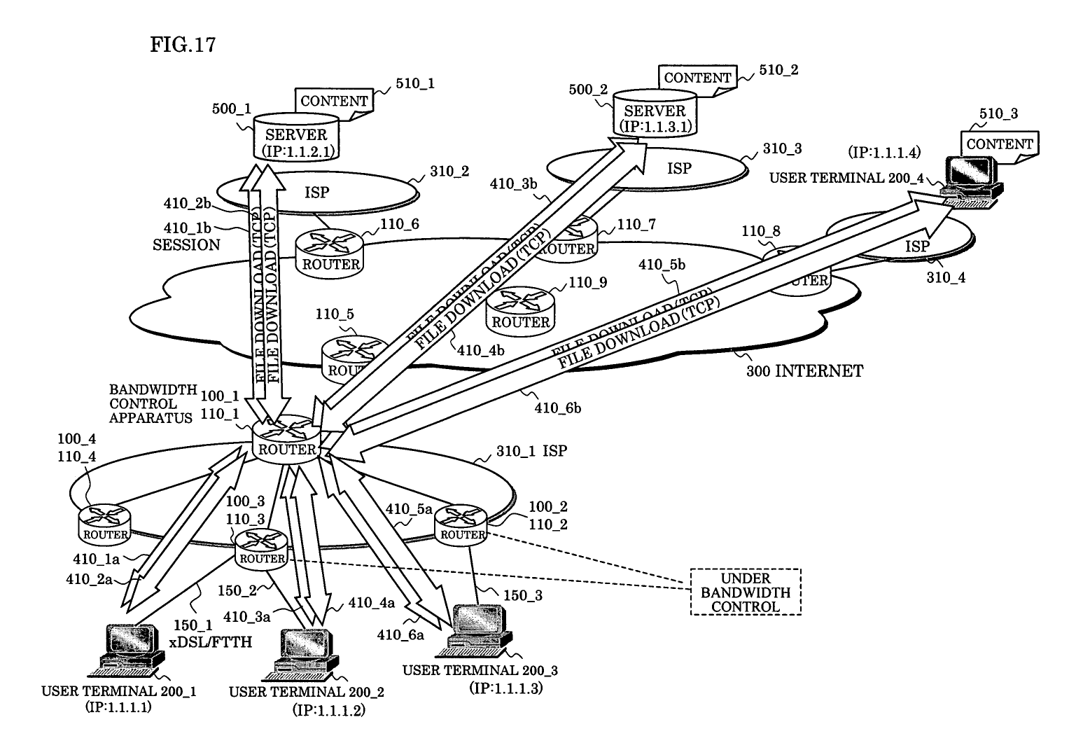

FIG. 17 shows a network state in which the bandwidth control of the embodiments (1)-(3) is performed. Since the bandwidth restriction is performed per user (in e.g. the bandwidth control apparatuses 100_2 and 100_3 of the routers 110_2 and 110_3 where the maximum bandwidth restriction value is exceeded in the embodiment (3)) in the present invention, it becomes possible to perform an equal bandwidth restriction without a packet discard due to a congestion and the occupation of the bandwidth by a specific user.

As described above, in the bandwidth control apparatus according to the present invention, a bandwidth measuring portion 10 measures a total bandwidth of a single or a plurality of TCP sessions for each user, and a window size changing portion 20a reduces a window size of a TCP session ACK packet of a user whose total bandwidth value exceeds a maximum bandwidth preset. Alternatively, an ACK time changing portion delays the ACK packet, thereby enabling a discard of a packet 700 for each user to be eliminated and bandwidths to be equally assigned to the user.

Namely, it can be avoided that a respective user bandwidth accommodated in a single router is kept extremely small by a heavy user (data transferer transferring large-capacity data at the same time zone), so that the best effort type equity can be kept.

Also, as data transfers of a certain router are increased, and a packet discard occurs due to a congestion state, a TCP retransmission control is performed for discarded packets, and a load to the network, the server or the like is imposed. However, if the bandwidth restriction is performed to the user, a frequency of the congestion occurrence can be reduced.

Also, by providing the bandwidth control apparatus of the present invention to a router in which a congestion easily occurs statistically, a prevention of packet discard by congestion and an optimum operation of a network are enabled.

1. A bandwidth control apparatus comprising:
a bandwidth measuring portion measuring a total bandwidth of a single or a plurality of TCP sessions for each user;
a determining portion determining whether or not the total bandwidth exceeds a maximum bandwidth value preset; and
a window size changing portion reducing a window size of a TCP session ACK packet of a user whose total bandwidth exceeds the maximum bandwidth value.

2. The bandwidth control apparatus as claimed in claim 1, wherein the determining portion determines whether or not the total bandwidth exceeds a bandwidth restriction release value preset, and the window size changing portion increases a window size of a TCP session ACK packet of a user whose total bandwidth does not exceed the bandwidth restriction release value.

3. A bandwidth control apparatus comprising:
a bandwidth measuring portion measuring a total bandwidth of a single or a plurality of TCP sessions for each user;
a determining portion determining whether or not the total bandwidth exceeds a maximum bandwidth value preset; and
an ACK time changing portion delaying a TCP session ACK packet of a user whose total bandwidth exceeds the maximum bandwidth value by a predetermined time.

4. The bandwidth control apparatus as claimed in claim 3, wherein the determining portion determines whether or not the total bandwidth exceeds a bandwidth restriction release value preset, and the ACK time changing portion reduces or eliminates the predetermined time of delay of the TCP session ACK packet of a user whose total bandwidth does not exceed the bandwidth restriction release value.

5. The bandwidth control apparatus as claimed in claim 3, wherein the predetermined time is determined based on a time from a reception of the ACK packet to a reception of a data packet for the ACK packet.

6. A bandwidth control apparatus comprising:
a bandwidth measuring portion measuring a total bandwidth of a single or a plurality of TCP sessions for each user and calculating a sum total bandwidth obtained by summing the total bandwidths of all of the users;
a determining portion determining whether or not the sum total bandwidth exceeds a maximum bandwidth restriction value determined based on a bandwidth of a whole apparatus; and
a bandwidth restricting portion performing a bandwidth restriction for each user only when the sum total bandwidth exceeds the maximum bandwidth restriction value.

7. The bandwidth control apparatus as claimed in claim 6, wherein the bandwidth restricting portion comprises a window size changing portion which reduces a window size of a TCP session ACK packet when the sum total bandwidth exceeds the maximum bandwidth restriction value.

8. The bandwidth control apparatus as claimed in claim 7, wherein the determining portion determines whether or not the total bandwidth exceeds a preset bandwidth restriction release value equal to or less than the maximum bandwidth restriction value, and the window size changing portion increases a window size of the TCP session ACK packet of a user whose total bandwidth does not exceed the bandwidth restriction release value.

9. The bandwidth control apparatus as claimed in claim 6, wherein the bandwidth restricting portion comprises an ACK time changing portion which delays a TCP session ACK packet when the sum total bandwidth exceeds the maximum bandwidth restriction value.

10. The bandwidth control apparatus as claimed in claim 9, wherein the determining portion determines whether or not the total bandwidth exceeds a preset bandwidth restriction release value equal to or less than the maximum bandwidth restriction value, and the ACK time changing portion reduces or eliminates a delay time of the TCP session ACK packet of a user whose total bandwidth does not exceed the bandwidth restriction release value.

11. The bandwidth control apparatus as claimed in claim 1, wherein the bandwidth measuring portion is provided with a timer measuring an inter-ACK time from a first ACK for a single or a plurality of first data packets to a second ACK for a single or a plurality of second data packets after the first ACK, a counting portion counting a data length of the single or the plurality of the second data packets, and a calculating portion making the total data length divided by the inter-ACK time a bandwidth value.
